(19) United States
(12) Patent Application Publication
(10) Pub. No.: US 2019/0387212 A1
(43) Pub. Date: Dec. 19, 2019

(54) 360 VIDEO PROCESSING METHOD AND APPARATUS THEREFOR

(71) Applicant: LG ELECTRONICS INC., Seoul (KR)

(72) Inventor: Sejin OH, Seoul (KR)

(73) Assignee: LG ELECTRONICS INC., Seoul (KR)

(21) Appl. No.: 16/489,984

(22) PCT Filed: May 25, 2018
(86) PCT No.: PCT/KR2018/005952

§ 371 Date: Aug. 29, 2019

Related U.S. Application Data
(60) Provisional application No. 62/511,351, filed on May 26, 2017.
(60) Provisional application No. 62/530,261, filed on Jul. 9, 2017.

(51) Int. Cl. H04N 13/178; H04N 13/161; H04N 13/194; G06T 3/00; G06T 7/80; G06T 5/00

(52) U.S. Cl. CPC H04N 13/178; H04N 13/161; G06T 5/006; G06T 3/0018; G06T 7/80; H04N 13/194

(57) ABSTRACT

A 360 video data processing method performed by a 360 video transmission device, according to the present invention comprises the steps of: acquiring 360-degree video data captured by at least one camera; deriving a two-dimensional-based picture including an omnidirectional image by processing the 360-degree video data; generating metadata for the 360-degree video data; encoding the picture; and processing storage or transmission for the encoded picture and the metadata, wherein a projection orientation rotation is applied to a projected picture on the basis of at least one of a yaw angle, a pitch angle and a roll angle, and the metadata includes projection orientation property information related to the projection orientation rotation.

### BACKGROUND OF THE INVENTION

### Field of the Invention

The present invention relates to 360 video and, most particularly, to a 360 video processing method and an apparatus for the same.

### Related Art

Virtual reality (VR) systems allow users to feel as if they are in electronically projected environments. Systems for providing VR can be improved in order to provide images with higher picture quality and spatial sounds. VR systems allow users to interactively consume VR content.

### SUMMARY OF THE INVENTION

### Technical Objects

A technical object of the present invention is to provide a VR video data processing method and apparatus for providing a VR system.

Another technical object of the present invention is to provide a method and apparatus for transmitting VR video data and metadata for the VR video data.

Yet another technical object of the present invention is to provide a method and apparatus for transmitting metadata for an efficient rendering of VR video.

### Technical Solutions

According to an exemplary embodiment of the present invention, provided herein is a 360-degree video data processing method performed by a 360-degree video transmitting apparatus. The method may include the steps of obtaining 360-degree video data being captured by at least one or more cameras, deriving a two-dimensional (2D)-based picture including an omnidirectional image by processing the 360-degree video data, generating metadata related to the 360-degree video data, encoding the picture, and performing processing for storage or transmission of the encoded picture and the metadata, wherein the deriving a 2D-based picture may include a step of deriving a projected picture by performing a projection procedure related to the 360-degree video data, wherein the 2D-based picture may correspond to the projected picture or corresponds to a packed picture being derived by performing a region-wise packing procedure related to the projected picture, wherein projection orientation rotation may be applied to the projected picture based on at least one of a yaw angle, a pitch angle, and a roll angle, and wherein the metadata may include projection orientation property information related to the projection orientation rotation.

According to another exemplary embodiment of the present invention, provided herein is a 360-degree video transmitting apparatus. The 360-degree video transmitting apparatus may include a data input unit obtaining 360-degree video data being captured by at least one or more cameras, a projection processor obtaining a two-dimensional (2D)-based picture by processing the 360-degree video data, a metadata processor generating metadata related to the 360-degree video data, an encoder encoding the picture, and a transmission processor performing processing for storage or transmission of the encoded picture and the metadata, wherein the projection processor derives a projected picture corresponding to the 2D-based picture by performing a projection procedure related to the 360-degree video data, wherein the projection processor applies projection orientation rotation to the projected picture based on at least one of a yaw angle, a pitch angle, and a roll angle, and wherein the metadata processor generates the metadata including projection orientation property information related to the projection orientation rotation.

According to yet another exemplary embodiment of the present invention, provided herein is a 360-degree video data processing method performed by a 360-degree video receiving apparatus. The method may include the steps of receiving a signal including information on a 2D based picture for 360-degree video and metadata for the 360-degree video,

processing the signal to obtain the information on the 2D based picture and the metadata, decoding the 2D based picture based on the information on the 2D based picture, and rendering the decoded picture on a 3D space by processing the decoded picture based on the metadata, wherein the metadata may include projection orientation property information on the projection orientation rotation, and wherein the rendering may be performed by applying orientation rotation for at least one of yaw angle, pitch angle and roll angle about the decoded picture based on the projection orientation property information.

According to a further exemplary embodiment of the present invention, provided herein is a 360-degree video receiving apparatus processing 360-degree video data. The receiving apparatus may include a receiving unit receiving a signal including information on a 2D based picture for 360-degree video and metadata for the 360-degree video, a reception processor processing the signal to obtain the information on the 2D based picture and the metadata, a decoder decoding the 2D based picture based on the information on the 2D based picture, and a renderer rendering the decoded picture on a 3D space by processing the decoded picture based on the metadata, wherein the metadata may include projection orientation property information on the projection orientation rotation, and wherein the rendering may be performed by applying orientation rotation for at least one of yaw angle, pitch angle and roll angle about the decoded picture based on the projection orientation property information.

### Effects of the Invention

According to the present invention, VR contents (360 contents) may be efficiently transmitted in an environment supporting next generation hybrid broadcasting, which uses both the terrestrial network and the Internet network.

According to the present invention, when a user consumes 360 contents, a solution for providing interactive experience may be proposed.

According to the present invention, when a user consumes 360 contents, a solution for performing signaling so that the intentions of a 360 contents provider can be accurately reflected may be proposed.

According to the present invention, when delivering 360 contents, a solution for efficiently expanding transmission capacity and allowing the necessary information to be transported (or delivered) may be proposed.

According to the present invention, signaling information corresponding to the 360-degree video data may be efficiently stored and transmitted via International Organization for Standardization (ISO) based media file formats, such as ISO base media file format (ISOBMFF), and so on.

According to the present invention, signaling information corresponding to the 360-degree video data may be transmitted via HyperText Transfer Protocol (HTTP) based adaptive streaming, such as Dynamic Adaptive Streaming over HTTP (DASH), and so on.

According to the present invention, signaling information corresponding to the 360-degree video data may be stored and transmitted via Supplemental enhancement information (SEI) message or Video Usability Information (VUI), and, accordingly, an overall transmission efficiency may be enhanced.

### BRIEF DESCRIPTION OF THE DRAWINGS

FIG. 1 is a view illustrating overall architecture for providing a 360-degree video according to the present invention.

FIGS. 2 and 3 are views illustrating a structure of a media file according to an embodiment of the present invention.

FIG. 4 illustrates an example of the overall operation of a DASH-based adaptive streaming model.

FIG. 5 is a view schematically illustrating a configuration of a 360-degree video transmission apparatus to which the present invention is applicable.

FIG. 6 is a view schematically illustrating a configuration of a 360-degree video reception apparatus to which the present invention is applicable.

FIG. 7 is a view illustrating the concept of aircraft principal axes for describing a 3D space of the present invention.

FIG. 8 illustrates a process of processing a 360-degree video and a 2D image to which a region-wise packing process according to a projection format is applied.

FIG. 9A and FIG. 9B illustrate projection formats according to the present invention.

FIG. 10A and FIG. 10B illustrate a tile according to an embodiment of the present invention.

FIG. 11 shows exemplary shapes of a sphere region.

FIG. 12 shows an example of a full radius, a picture radius, and a scene radius.

FIG. 13 shows an exemplary FOV of fisheye images.

FIG. 14 shows examples of camera_center_offset_x (ox), camera_center_offset_y (oy), and camera_center_offset_z (oz).

FIG. 15 shows an exemplary local FOV according to a parameter.

FIG. 16 shows a general view of a 360 video data processing method performed by a 360 video transmitting device according to the present invention.

FIG. 17 shows a general view of a 360 video data processing method performed by a 360 video receiving device according to the present invention.

### DESCRIPTION OF EXEMPLARY EMBODIMENTS

The present invention may be modified in various forms, and specific embodiments thereof will be described and illustrated in the drawings. However, the embodiments are not intended for limiting the invention. The terms used in the following description are used to merely describe specific embodiments, but are not intended to limit the invention. An expression of a singular number includes an expression of the plural number, so long as it is clearly read differently. The terms such as “include” and “have” are intended to indicate that features, numbers, steps, operations, elements, components, or combinations thereof used in the following description exist and it should be thus understood that the possibility of existence or addition of one or more different features, numbers, steps, operations, elements, components, or combinations thereof is not excluded.

On the other hand, elements in the drawings described in the invention are independently drawn for the purpose of convenience for explanation of different specific functions, and do not mean that the elements are embodied by independent hardware or independent software. For example, two or more elements of the elements may be combined to form a single element, or one element may be divided into plural elements. The embodiments in which the elements are combined and/or divided belong to the invention without departing from the concept of the invention.

Hereinafter, preferred embodiments of the present invention will be described in more detail with reference to the attached drawings. Hereinafter, the same reference numbers will be used throughout this specification to refer to the same components and redundant description of the same component will be omitted.

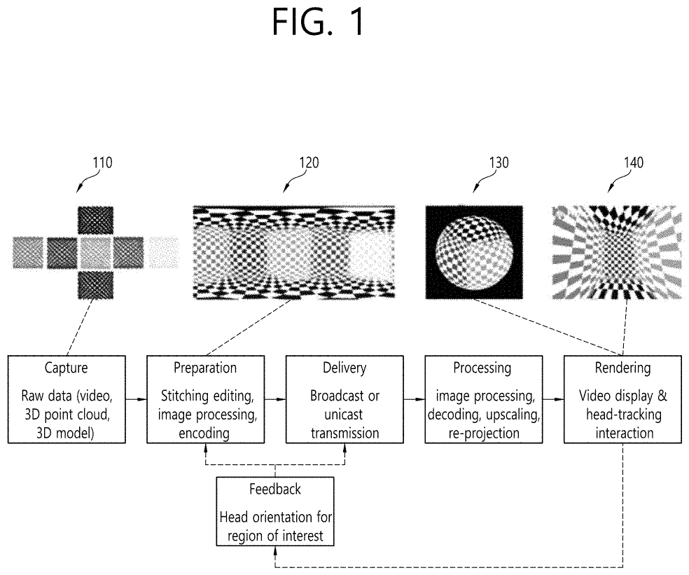

FIG. 1 is a view illustrating overall architecture for providing a 360-degree video according to the present invention.

The present invention proposes a method of providing 360-degree content in order to provide virtual reality (VR) to users. VR may refer to technology for replicating actual or virtual environments or those environments. VR artificially provides sensory experience to users and thus users can experience electronically projected environments.

360-degree content refers to content for realizing and providing VR and may include a 360-degree video and/or 360-degree audio. The 360-degree video may refer to video or image content which is necessary to provide VR and is captured or reproduced omnidirectionally (360 degrees). Hereinafter, the 360-degree video may refer to 360-degree video. A 360-degree video may refer to a video or an image represented on 3D spaces in various forms according to 3D models. For example, a 360-degree video can be represented on a spherical surface. The 360-degree audio is audio content for providing VR and may refer to spatial audio content whose audio generation source can be recognized to be located in a specific 3D space. 360-degree content may be generated, processed and transmitted to users and users can consume VR experiences using the 360-degree content. A 360-degree video may be referred to as an omnidirectional video, and a 360-degree image may be referred to as an omnidirectional image.

Particularly, the present invention proposes a method for effectively providing a 360-degree video. To provide a 360-degree video, a 360-degree video may be captured through one or more cameras. The captured 360-degree video may be transmitted through series of processes and a reception side may process the transmitted 360-degree video into the original 360-degree video and render the 360-degree video. In this manner, the 360-degree video can be provided to a user.

Specifically, processes for providing a 360-degree video may include a capture process, a preparation process, a transmission process, a processing process, a rendering process and/or a feedback process.

The capture process may refer to a process of capturing images or videos for a plurality of viewpoints through one or more cameras. Image/video data (110) shown in FIG. 1 may be generated through the capture process. Each plane of (110) in FIG. 1 may represent an image/video for each viewpoint. A plurality of captured images/videos may be referred to as raw data. Metadata related to capture can be generated during the capture process.

For capture, a special camera for VR may be used. When a 360-degree video with respect to a virtual space generated by a computer is provided according to an embodiment, capture through an actual camera may not be performed. In this case, a process of simply generating related data can substitute for the capture process.

The preparation process may be a process of processing captured images/videos and metadata generated in the capture process. Captured images/videos may be subjected to a stitching process, a projection process, a region-wise packing process and/or an encoding process during the preparation process.

First, each image/video may be subjected to the stitching process. The stitching process may be a process of connecting captured images/videos to generate one panorama image/video or spherical image/video.

Subsequently, stitched images/videos may be subjected to the projection process. In the projection process, the stitched images/videos may be projected on 2D image. The 2D image may be called a 2D image frame according to context. Projection on a 2D image may be referred to as mapping to a 2D image. Projected image/video data may have the form of a 2D image (120) in FIG. 1.

Video data projected on the 2D image may be subjected to the region-wise packing process in order to improve video coding efficiency. Region-wise packing may refer to a process of processing video data projected on a 2D image for each region. Here, regions may refer to divided areas of a 2D image on which 360-degree video data is projected. Regions can be obtained by dividing a 2D image equally or arbitrarily according to an embodiment. Further, regions may be divided according to a projection scheme in an embodiment. The region-wise packing process is an optional process and may be omitted in the preparation process.

The processing process may include a process of rotating regions or rearranging the regions on a 2D image in order to improve video coding efficiency according to an embodiment. For example, it is possible to rotate regions such that specific sides of regions are positioned in proximity to each other to improve coding efficiency.

The processing process may include a process of increasing or decreasing resolution for a specific region in order to differentiate resolutions for regions of a 360-degree video according to an embodiment. For example, it is possible to increase the resolution of regions corresponding to relatively more important regions in a 360-degree video to be higher than the resolution of other regions. Video data projected on the 2D image or region-wise packed video data may be subjected to the encoding process through a video codec.

According to an embodiment, the preparation process may further include an additional editing process. In this editing process, editing of image/video data before and after projection may be performed. In the preparation process, metadata regarding stitching/projection/encoding/editing may also be generated. Further, metadata regarding an initial viewpoint or a region of interest (ROI) of video data projected on the 2D image may be generated.

The transmission process may be a process of processing and transmitting image/video data and metadata which have passed through the preparation process. Processing according to an arbitrary transmission protocol may be performed for transmission. Data which has been processed for transmission may be delivered through a broadcast network and/or a broadband. Such data may be delivered to a reception side in an on-demand manner. The reception side may receive the data through various paths.

The processing process may refer to a process of decoding received data and re-projecting projected image/video data on a 3D model. In this process, image/video data projected on the 2D image may be re-projected on a 3D space. This process may be called mapping or projection according to context. Here, 3D model to which image/video data is mapped may have different forms according to 3D models. For example, 3D models may include a sphere, a cube, a cylinder and a pyramid.

According to an embodiment, the processing process may additionally include an editing process and an up-scaling process. In the editing process, editing of image/video data before and after re-projection may be further performed. When the image/video data has been reduced, the size of the image/video data can be increased by up-scaling samples in the up-scaling process. An operation of decreasing the size through down-scaling may be performed as necessary.

The rendering process may refer to a process of rendering and displaying the image/video data re-projected on the 3D space. Re-projection and rendering may be combined and represented as rendering on a 3D model. An image/video re-projected on a 3D model (or rendered on a 3D model) may have a form (130) shown in FIG. 1. The form (130) shown in FIG. 1 corresponds to a case in which the image/video is re-projected on a 3D spherical model. A user can view a region of the rendered image/video through a VR display. Here, the region viewed by the user may have a form (140) shown in FIG. 1.

The feedback process may refer to a process of delivering various types of feedback information which can be acquired in a display process to a transmission side. Interactivity in consumption of a 360-degree video can be provided through the feedback process. According to an embodiment, head orientation information, viewport information representing a region currently viewed by a user, and the like can be delivered to a transmission side in the feedback process. According to an embodiment, a user may interact with an object realized in a VR environment. In this case, information about the interaction may be delivered to a transmission side or a service provider in the feedback process. According to an embodiment, the feedback process may not be performed.

The head orientation information may refer to information about the position, angle, motion and the like of the head of a user. Based on this information, information about a region in a 360-degree video which is currently viewed by the user, that is, viewport information, can be calculated.

The viewport information may be information about a region in a 360-degree video which is currently viewed by a user. Gaze analysis may be performed through the viewpoint information to check how the user consumes the 360-degree video, which region of the 360-degree video is gazed by the user, how long the region is gazed, and the like. Gaze analysis may be performed at a reception side and a result thereof may be delivered to a transmission side through a feedback channel A device such as a VR display may extract a viewport region based on the position/direction of the head of a user, information on a vertical or horizontal field of view (FOV) supported by the device, and the like.

According to an embodiment, the aforementioned feedback information may be consumed at a reception side as well as being transmitted to a transmission side. That is, decoding, re-projection and rendering at the reception side may be performed using the aforementioned feedback information. For example, only a 360-degree video with respect to a region currently viewed by the user may be preferentially decoded and rendered using the head orientation information and/or the viewport information.

Here, a viewport or a viewport region may refer to a region in a 360-degree video being viewed by a user. A viewpoint is a point in a 360-degree video being viewed by a user and may refer to a center point of a viewport region. That is, a viewport is a region having a viewpoint at the center thereof, and the size and the shape of the region can be determined by an FOV which will be described later.

In the above-described overall architecture for providing a 360-degree video, image/video data which is subjected to the capture/projection/encoding/transmission/decoding/re-projection/rendering processes may be referred to as 360-degree video data. The term “360-degree video data” may be used as the concept including metadata and signaling information related to such image/video data.

To store and transmit media data such as the aforementioned audio and video data, a standardized media file format may be defined. According to an embodiment, a media file may have a file format based on ISO BMFF (ISO base media file format).

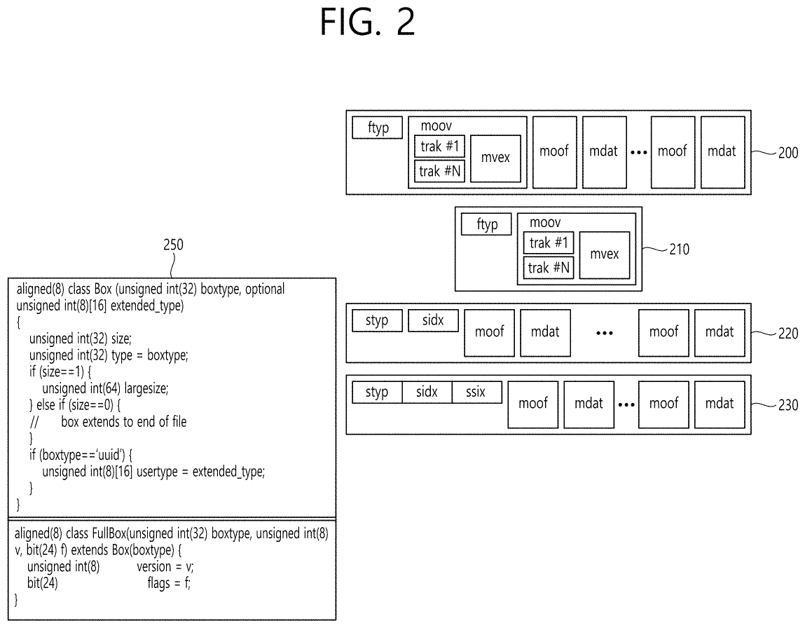

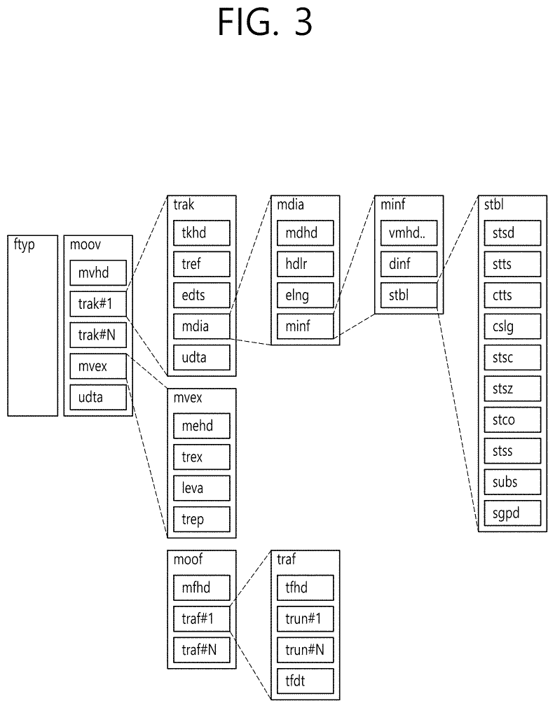

FIGS. 2 and 3 are views illustrating a structure of a media file according to an embodiment of the present invention.

The media file according to the present invention may include at least one box. Here, a box may be a data block or an object including media data or metadata related to media data. Boxes may be in a hierarchical structure and thus data can be classified and media files can have a format suitable for storage and/or transmission of large-capacity media data. Further, media files may have a structure which allows users to easily access media information such as moving to a specific point of media content.

The media file according to the present invention may include an ftyp box, a moov box and/or an mdat box.

The ftyp box (file type box) can provide file type or compatibility related information about the corresponding media file. The ftyp box may include configuration version information about media data of the corresponding media file. A decoder can identify the corresponding media file with reference to ftyp box.

The moov box (movie box) may be a box including metadata about media data of the corresponding media file. The moov box may serve as a container for all metadata. The moov box may be a highest layer among boxes related to metadata. According to an embodiment, only one moov box may be present in a media file.

The mdat box (media data box) may be a box containing actual media data of the corresponding media file. Media data may include audio samples and/or video samples. The mdat box may serve as a container containing such media samples.

According to an embodiment, the aforementioned moov box may further include an mvhd box, a trak box and/or an mvex box as lower boxes.

The mvhd box (movie header box) may include information related to media presentation of media data included in the corresponding media file. That is, the mvhd box may include information such as a media generation time, change time, time standard and period of corresponding media presentation.

The trak box (track box) can provide information about a track of corresponding media data. The trak box can include information such as stream related information, presentation related information and access related information about an audio track or a video track. A plurality of trak boxes may be present depending on the number of tracks.

The trak box may further include a tkhd box (track head box) as a lower box. The tkhd box can include information about the track indicated by the trak box. The tkhd box can include information such as a generation time, a change time and a track identifier of the corresponding track.

The mvex box (movie extend box) can indicate that the corresponding media file may have a moof box which will be described later. To recognize all media samples of a specific track, moof boxes may need to be scanned.

According to an embodiment, the media file according to the present invention may be divided into a plurality of fragments (200). Accordingly, the media file can be fragmented and stored or transmitted. Media data (mdat box) of the media file can be divided into a plurality of fragments and each fragment can include a moof box and a divided mdat box. According to an embodiment, information of the ftyp box and/or the moov box may be required to use the fragments.

The moof box (movie fragment box) can provide metadata about media data of the corresponding fragment. The moof box may be a highest-layer box among boxes related to metadata of the corresponding fragment.

The mdat box (media data box) can include actual media data as described above. The mdat box can include media samples of media data corresponding to each fragment corresponding thereto.

According to an embodiment, the aforementioned moof box may further include an mfhd box and/or a traf box as lower boxes.

The mfhd box (movie fragment header box) can include information about correlation between divided fragments. The mfhd box can indicate the order of divided media data of the corresponding fragment by including a sequence number. Further, it is possible to check whether there is missed data among divided data using the mfhd box.

The traf box (track fragment box) can include information about the corresponding track fragment. The traf box can provide metadata about a divided track fragment included in the corresponding fragment. The traf box can provide metadata such that media samples in the corresponding track fragment can be decoded/reproduced. A plurality of traf boxes may be present depending on the number of track fragments.

According to an embodiment, the aforementioned traf box may further include a tfhd box and/or a trun box as lower boxes.

The tfhd box (track fragment header box) can include header information of the corresponding track fragment. The tfhd box can provide information such as a basic sample size, a period, an offset and an identifier for media samples of the track fragment indicated by the aforementioned traf box.

The trun box (track fragment run box) can include information related to the corresponding track fragment. The trun box can include information such as a period, a size and a reproduction time for each media sample.

The aforementioned media file and fragments thereof can be processed into segments and transmitted. Segments may include an initialization segment and/or a media segment.

A file of the illustrated embodiment (210) may include information related to media decoder initialization except media data. This file may correspond to the aforementioned initialization segment, for example. The initialization segment can include the aforementioned ftyp box and/or moov box.

A file of the illustrated embodiment (220) may include the aforementioned fragment. This file may correspond to the aforementioned media segment, for example. The media segment may further include an styp box and/or an sidx box.

The styp box (segment type box) can provide information for identifying media data of a divided fragment. The styp box can serve as the aforementioned ftyp box for a divided fragment. According to an embodiment, the styp box may have the same format as the ftyp box.

The sidx box (segment index box) can provide information indicating an index of a divided fragment. Accordingly, the order of the divided fragment can be indicated.

According to an embodiment (230), an ssix box may be further included. The ssix box (sub-segment index box) can provide information indicating an index of a sub-segment when a segment is divided into sub-segments.

Boxes in a media file can include more extended information based on a box or a FullBox as shown in the illustrated embodiment (250). In the present embodiment, a size field and a largesize field can represent the length of the corresponding box in bytes. A version field can indicate the version of the corresponding box format. A type field can indicate the type or identifier of the corresponding box. A flags field can indicate a flag associated with the corresponding box.

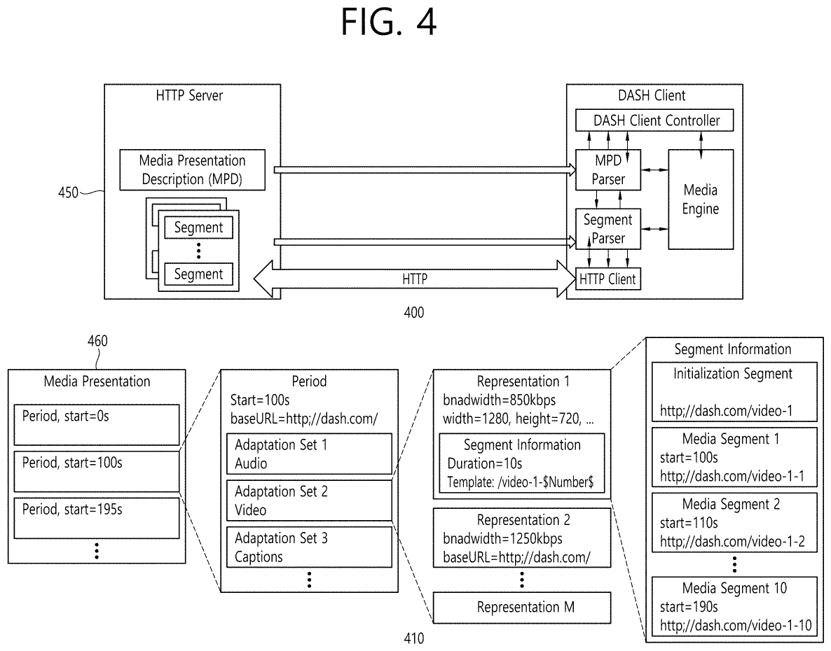

FIG. 4 illustrates an example of the overall operation of a DASH-based adaptive streaming model. The DASH-based adaptive streaming model according to an illustrated embodiment (400) illustrates an operation between an HTTP server and a DASH client. Here, Dynamic Adaptive Streaming over HTTP (DASH) is a protocol for supporting HTTP-based adaptive streaming and can dynamically support streaming according to a network state. Accordingly, AV content may be seamlessly reproduced.

First, the DASH client may acquire an MPD. The MPD may be delivered from a service provider, such as the HTTP server. The DASH client may request a segment from the server using segment access information described in the MPD. Here, this request may be performed in view of the network condition.

After acquiring the segment, the DASH client may process the segment in a media engine and may display the segment on a screen. The DASH client may request and acquire a necessary segment in view of reproduction time and/or the network state in real time (adaptive streaming) Accordingly, content may be seamlessly reproduced.

The media presentation description (MPD) is a file including detailed information for allowing the DASH client to dynamically acquire a segment and may be expressed in XML format.

A DASH client controller may generate a command to request an MPD and/or a segment in view of the network state. In addition, the controller may control acquired information to be used in an internal block, such as the media engine.

An MPD parser may parse the acquired MPD in real time. Accordingly, the DASH client controller can generate a command to acquire a required segment.

A segment parser may parse the acquired segment in real time. Depending on pieces of information included in the segment, internal blocks including the media engine may perform certain operations.

An HTTP client may request a required MPD and/or segment from the HTTP server. The HTTP client may also deliver an MPD and/or segment acquired from the server to the MPD parser or the segment parser.

The media engine may display content on a screen using media data included in the segment. Here, pieces of information of the MPD may be used.

A DASH data model may have a hierarchical structure (410). A media presentation may be described by the MPD. The MPD may describe a temporal sequence of a plurality of periods forming a media presentation. A period may represent one section of media content.

In one section, pieces of data may be included in adaptation sets. An adaptation set may be a collection of a plurality of media content components that can be exchanged with each other. An adaptation set may include a collection of representations. A representation may correspond to a media content component. Within one representation, content may be temporally divided into a plurality of segments, which may be for proper accessibility and delivery. The URL of each segment may be provided to enable access to each segment.

The MPD may provide information related to the media presentation, and a period element, an adaptation set element, and a presentation element may describe a period, an adaptation set, and a presentation, respectively. A representation may be divided into sub-representations, and a sub-representation element may describe a sub-representation.

Common properties/elements may be defined, which may be applied to (included in) an adaptation set, a representations, a sub-representation, or the like. Among the common properties/elements, there may be an essential property and/or a supplemental property.

The essential property may be information including elements that are considered essential in processing media presentation-related data. The supplemental property may be information including elements that may be used for processing the media presentation-related data. Descriptors to be described in the following embodiments may be defined and delivered in an essential property and/or a supplemental property when delivered via the MPD.

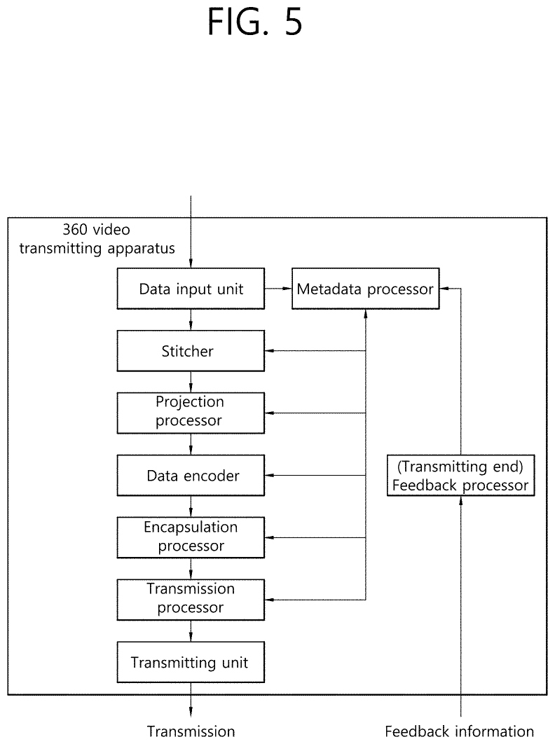

FIG. 5 is a view schematically illustrating a configuration of a 360-degree video transmission apparatus to which the present invention is applicable.

The 360-degree video transmission apparatus according to the present invention can perform operations related the above-described preparation process and the transmission process. The 360-degree video transmission apparatus may include a data input unit, a stitcher, a projection processor, a region-wise packing processor (not shown), a metadata processor, a (transmission side) feedback processor, a data encoder, an encapsulation processor, a transmission processor, and/or a transmitter as internal/external elements.

The data input unit can receive captured images/videos for respective viewpoints. The images/videos for the respective viewpoints may be images/videos captured by one or more cameras. Further, data input unit may receive metadata generated in a capture process. The data input unit may forward the received images/videos for the viewpoints to the stitcher and forward metadata generated in the capture process to the signaling processor.

The stitcher can perform a stitching operation on the captured images/videos for the viewpoints. The stitcher may forward stitched 360-degree video data to the projection processor. The stitcher may receive necessary metadata from the metadata processor and use the metadata for the stitching operation as necessary. The stitcher may forward metadata generated in the stitching process to the metadata processor. The metadata in the stitching process may include information such as information representing whether stitching has been performed, and a stitching type.

The projection processor can project the stitched 360-degree video data on a 2D image. The projection processor may perform projection according to various schemes which will be described later. The projection processor may perform mapping in consideration of the depth of 360-degree video data for each viewpoint. The projection processor may receive metadata necessary for projection from the metadata processor and use the metadata for the projection operation as necessary. The projection processor may forward metadata generated in the projection process to the metadata processor. Metadata generated in the projection processor may include a projection scheme type and the like.

The region-wise packing processor (not shown) can perform the aforementioned region-wise packing process. That is, the region-wise packing processor can perform the process of dividing the projected 360-degree video data into regions and rotating and rearranging regions or changing the resolution of each region. As described above, the region-wise packing process is optional and thus the region-wise packing processor may be omitted when region-wise packing is not performed. The region-wise packing processor may receive metadata necessary for region-wise packing from the metadata processor and use the metadata for a region-wise packing operation as necessary. The region-wise packing processor may forward metadata generated in the region-wise packing process to the metadata processor. Metadata generated in the region-wise packing processor may include a rotation degree, size and the like of each region.

The aforementioned stitcher, projection processor and/or the region-wise packing processor may be integrated into a single hardware component according to an embodiment.

The metadata processor can process metadata which may be generated in a capture process, a stitching process, a projection process, a region-wise packing process, an encoding process, an encapsulation process and/or a process for transmission. The metadata processor can generate 360-degree video-related metadata using such metadata. According to an embodiment, the metadata processor may generate the 360-degree video-related metadata in the form of a signaling table. 360-degree video-related metadata may also be called metadata or 360-degree video related signaling information according to signaling context. Further, the metadata processor may forward the acquired or generated metadata to internal elements of the 360-degree video transmission apparatus as necessary. The metadata processor may forward the 360-degree video-related metadata to the data encoder, the encapsulation processor and/or the transmission processor such that the 360-degree video-related metadata can be transmitted to a reception side.

The data encoder can encode the 360-degree video data projected on the 2D image and/or region-wise packed 360-degree video data. The 360-degree video data can be encoded in various formats.

The encapsulation processor can encapsulate the encoded 360-degree video data and/or 360-degree video-related metadata in a file format. Here, the 360-degree video-related metadata may be received from the metadata processor. The encapsulation processor can encapsulate the data in a file format such as ISOBMFF, CFF or the like or process the data into a DASH segment or the like. The encapsulation processor may include the 360-degree video-related metadata in a file format. The 360-degree video-related metadata may be included in a box having various levels in SOBMFF or may be included as data of a separate track in a file, for example. According to an embodiment, the encapsulation processor may encapsulate the 360-degree video-related metadata into a file. The transmission processor may perform processing for transmission on the encapsulated 360-degree video data according to file format. The transmission processor may process the 360-degree video data according to an arbitrary transmission protocol. The processing for transmission may include processing for delivery over a broadcast network and processing for delivery over a broadband. According to an embodiment, the transmission processor may receive 360-degree video-related metadata from the metadata processor as well as the 360-degree video data and perform the processing for transmission on the 360-degree video-related metadata.

The transmitter can transmit the 360-degree video data and/or the 360-degree video-related metadata processed for transmission through a broadcast network and/or a broadband. The transmitter may include an element for transmission through a broadcast network and/or an element for transmission through a broadband.

According to an embodiment of the 360-degree video transmission apparatus according to the present invention, the 360-degree video transmission apparatus may further include a data storage unit (not shown) as an internal/external element. The data storage unit may store encoded 360-degree video data and/or 360-degree video-related metadata before the encoded 360-degree video data and/or 360-degree video-related metadata are delivered to the transmission processor. Such data may be stored in a file format such as ISOBMFF. Although the data storage unit may not be required when 360-degree video is transmitted in real time, encapsulated 360-degree data may be stored in the data storage unit for a certain period of time and then transmitted when the encapsulated 360-degree data is delivered over a broadband.

According to another embodiment of the 360-degree video transmission apparatus according to the present invention, the 360-degree video transmission apparatus may further include a (transmission side) feedback processor and/or a network interface (not shown) as internal/external elements. The network interface can receive feedback information from a 360-degree video reception apparatus according to the present invention and forward the feedback information to the transmission side feedback processor. The transmission side feedback processor can forward the feedback information to the stitcher, the projection processor, the region-wise packing processor, the data encoder, the encapsulation processor, the metadata processor and/or the transmission processor. According to an embodiment, the feedback information may be delivered to the metadata processor and then delivered to each internal element. Internal elements which have received the feedback information can reflect the feedback information in the following 360-degree video data processing.

According to another embodiment of the 360-degree video transmission apparatus according to the present invention, the region-wise packing processor may rotate regions and map the rotated regions on a 2D image. Here, the regions may be rotated in different directions at different angles and mapped on the 2D image. Region rotation may be performed in consideration of neighboring parts and stitched parts of 360-degree video data on a spherical surface before projection. Information about region rotation, that is, rotation directions, angles and the like may be signaled through 360-degree video-related metadata. According to another embodiment of the 360-degree video transmission apparatus according to the present invention, the data encoder may perform encoding differently for respective regions. The data encoder may encode a specific region in high quality and encode other regions in low quality. The transmission side feedback processor may forward feedback information received from the 360-degree video reception apparatus to the data encoder such that the data encoder can use encoding methods differentiated for respective regions. For example, the transmission side feedback processor may forward viewport information received from a reception side to the data encoder. The data encoder may encode regions including an area indicated by the viewport information in higher quality (UHD and the like) than that of other regions.

According to another embodiment of the 360-degree video transmission apparatus according to the present invention, the transmission processor may perform processing for transmission differently for respective regions. The transmission processor may apply different transmission parameters (modulation orders, code rates, and the like) to the respective regions such that data delivered to the respective regions have different robustnesses.

Here, the transmission side feedback processor may forward feedback information received from the 360-degree video reception apparatus to the transmission processor such that the transmission processor can perform transmission processes differentiated for respective regions. For example, the transmission side feedback processor may forward viewport information received from a reception side to the transmission processor. The transmission processor may perform a transmission process on regions including an area indicated by the viewport information such that the regions have higher robustness than other regions.

The above-described internal/external elements of the 360-degree video transmission apparatus according to the present invention may be hardware elements. According to an embodiment, the internal/external elements may be changed, omitted, replaced by other elements or integrated.

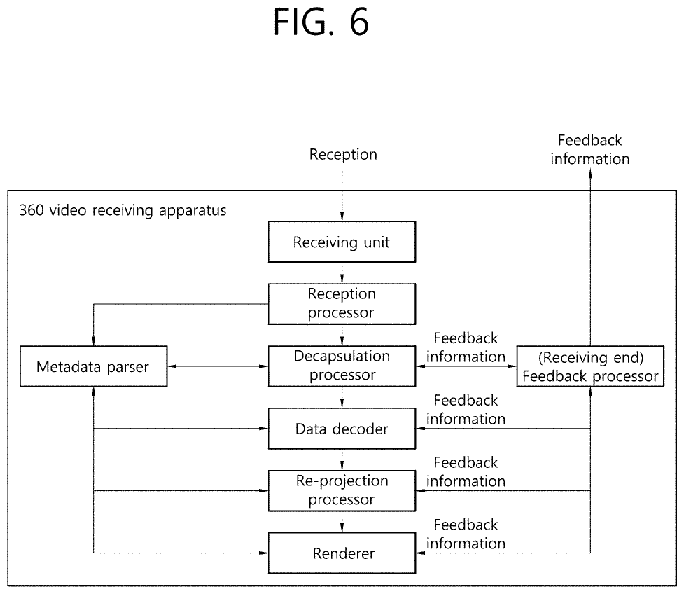

FIG. 6 is a view schematically illustrating a configuration of a 360-degree video reception apparatus to which the present invention is applicable.

The 360-degree video reception apparatus according to the present invention can perform operations related to the above-described processing process and/or the rendering process. The 360-degree video reception apparatus may include a receiver, a reception processor, a decapsulation processor, a data decoder, a metadata parser, a (reception side) feedback processor, a re-projection processor, and/or a renderer as internal/external elements. A signaling parser may be called the metadata parser.

The receiver can receive 360-degree video data transmitted from the 360-degree video transmission apparatus according to the present invention. The receiver may receive the 360-degree video data through a broadcast network or a broadband depending on a channel through which the 360-degree video data is transmitted.

The reception processor can perform processing according to a transmission protocol on the received 360-degree video data. The reception processor may perform a reverse process of the process of the aforementioned transmission processor such that the reverse process corresponds to processing for transmission performed at the transmission side. The reception processor can forward the acquired 360-degree video data to the decapsulation processor and forward acquired 360-degree video-related metadata to the metadata parser. The 360-degree video-related metadata acquired by the reception processor may have the form of a signaling table.

The decapsulation processor can decapsulate the 360-degree video data in a file format received from the reception processor. The decapsulation processor can acquired 360-degree video data and 360-degree video-related metadata by decapsulating files in ISOBMFF or the like. The decapsulation processor can forward the acquired 360-degree video data to the data decoder and forward the acquired 360-degree video-related metadata to the metadata parser. The 360-degree video-related metadata acquired by the decapsulation processor may have the form of a box or a track in a file format. The decapsulation processor may receive metadata necessary for decapsulation from the metadata parser as necessary.

The data decoder can decode the 360-degree video data. The data decoder may receive metadata necessary for decoding from the metadata parser. The 360-degree video-related metadata acquired in the data decoding process may be forwarded to the metadata parser.

The metadata parser can parse/decode the 360-degree video-related metadata. The metadata parser can forward acquired metadata to the data decapsulation processor, the data decoder, the re-projection processor and/or the renderer.

The re-projection processor can perform re-projection on the decoded 360-degree video data. The re-projection processor can re-project the 360-degree video data on a 3D space. The 3D space may have different forms depending on 3D models. The re-projection processor may receive metadata necessary for re-projection from the metadata parser. For example, the re-projection processor may receive information about the type of a used 3D model and detailed information thereof from the metadata parser. According to an embodiment, the re-projection processor may re-project only 360-degree video data corresponding to a specific area of the 3D space on the 3D space using metadata necessary for re-projection.

The renderer can render the re-projected 360-degree video data. As described above, re-projection of 360-degree video data on a 3D space may be represented as rendering of 360-degree video data on the 3D space. When two processes simultaneously occur in this manner, the re-projection processor and the renderer may be integrated and the renderer may perform the processes. According to an embodiment, the renderer may render only a part viewed by a user according to viewpoint information of the user.

The user may view a part of the rendered 360-degree video through a VR display or the like. The VR display is a device which reproduces a 360-degree video and may be included in a 360-degree video reception apparatus (tethered) or connected to the 360-degree video reception apparatus as a separate device (un-tethered).

According to an embodiment of the 360-degree video reception apparatus according to the present invention, the 360-degree video reception apparatus may further include a (reception side) feedback processor and/or a network interface (not shown) as internal/external elements. The reception side feedback processor can acquire feedback information from the renderer, the re-projection processor, the data decoder, the decapsulation processor and/or the VR display and process the feedback information. The feedback information may include viewport information, head orientation information, gaze information, and the like. The network interface can receive the feedback information from the reception side feedback processor and transmit the feedback information to a 360-degree video transmission apparatus.

As described above, the feedback information may be consumed at the reception side as well as being transmitted to the transmission side. The reception side feedback processor may forward the acquired feedback information to internal elements of the 360-degree video reception apparatus such that the feedback information is reflected in processes such as rendering. The reception side feedback processor can forward the feedback information to the renderer, the re-projection processor, the data decoder and/or the decapsulation processor. For example, the renderer can preferentially render an area viewed by the user using the feedback information. In addition, the decapsulation processor and the data decoder can preferentially decapsulate and decode an area being viewed or will be viewed by the user.

The above-described internal/external elements of the 360-degree video reception apparatus according to the present invention may be hardware elements. According to an embodiment, the internal/external elements may be changed, omitted, replaced by other elements or integrated. According to an embodiment, additional elements may be added to the 360-degree video reception apparatus.

Another aspect of the present invention may pertain to a method for transmitting a 360-degree video and a method for receiving a 360-degree video. The methods for transmitting/receiving a 360-degree video according to the present invention may be performed by the above-described 360-degree video transmission/reception apparatuses or embodiments thereof.

Embodiments of the above-described 360-degree video transmission/reception apparatuses and transmission/reception methods and embodiments of the internal/external elements of the apparatuses may be combined. For example, embodiments of the projection processor and embodiments of the data encoder may be combined to generate as many embodiments of the 360-degree video transmission apparatus as the number of cases. Embodiments combined in this manner are also included in the scope of the present invention.

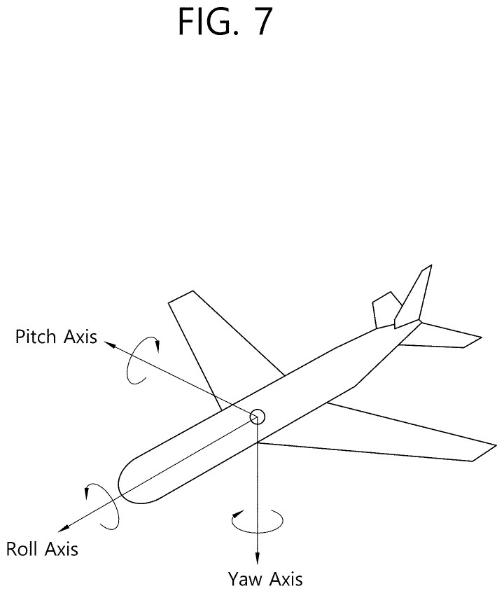

FIG. 7 is a view illustrating the concept of aircraft principal axes for describing a 3D space of the present invention. In the present invention, the concept of aircraft principal axes can be used to represent a specific point, position, direction, interval, region and the like in a 3D space. That is, the content of aircraft principal axes can be used to describe a 3D space before projection or after reprojection and perform signaling therefor in the present invention. According to an embodiment, a method using the concept of X, Y and Z axes or spherical coordinates may be used.

An aircraft can freely rotate three-dimensionally. Axes constituting a three dimension are referred to as a pitch axis, a yaw axis and a roll axis. These may be referred to as a pitch, a yaw and a roll or a pitch direction, a yaw direction and a roll direction in the description.

The pitch axis can refer to an axis which is a base of a direction in which the front end of the aircraft rotates up and down. In the illustrated concept of aircraft principal axes, the pitch axis can refer to an axis which connects the wings of the aircraft.

The yaw axis can refer to an axis which is a base of a direction in which the front end of the aircraft rotates to the left and right. In the illustrated concept of aircraft principal axes, the yaw axis can refer to an axis which connects the top to the bottom of the aircraft. The roll axis can refer to an axis which connects the front end to the tail of the aircraft in the illustrated concept of aircraft principal axes, and a rotation in the roll direction can refer to a rotation based on the roll axis. As described above, a 3D space in the present invention can be described using the concept of the pitch, yaw and roll.

As described above, video data projected on a 2D image may be subjected to region-wise packing in order to enhance video coding efficiency. Region-wise packing may refer to a process of processing video data projected on a 2D image by regions. Here, regions may refer to divided areas of a 2D image on which 360-degree video data is projected. Divided regions of a 2D image may be divided according to a projection scheme. A 2D image may be referred to as a video frame or a frame.

The present invention proposes metadata about a region-wise packing process according to a projection scheme and a method of signaling the metadata. The region-wise packing process may be efficiently performed based on the metadata.

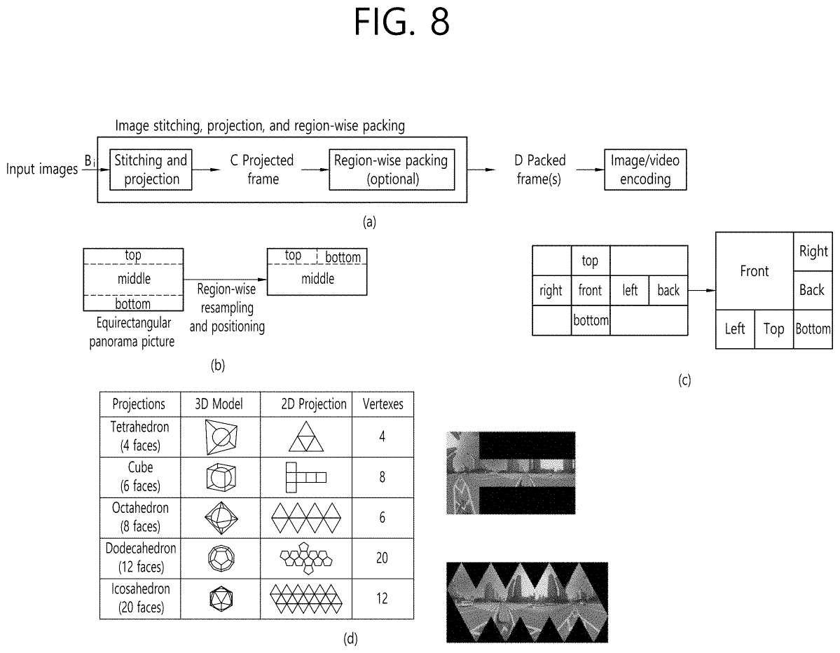

FIG. 8 illustrates a process of processing a 360-degree video and a 2D image to which a region-wise packing process according to a projection format is applied. In FIG. 8, (a) illustrates a process of processing input 360-degree video data. Referring to (a) of FIG. 8, input 360-degree video data from a viewpoint may be stitched and projected on a 3D projection structure according to various projection schemes, and the 360-degree video data projected on the 3D projection structure may be represented as a 2D image. That is, the 360-degree video data may be stitched and may be projected into the 2D image. The 2D image into which the 360-degree video data is projected may be referred to as a projected frame. The projected frame may be subjected to the above-described region-wise packing process. Specifically, the projected frame may be processed such that an area including the projected 360-degree video data on the projected frame may be divided into regions, and each region may be rotated or rearranged, or the resolution of each region may be changed. That is, the region-wise packing process may indicate a process of mapping the projected frame to one or more packed frames. The region-wise packing process may be optionally performed. When the region-wise packing process is not applied, the packed frame and the projected frame may be the same. When the region-wise packing process is applied, each region of the projected frame may be mapped to a region of the packed frame, and metadata indicating the position, shape, shape, and the size of the region of the packed frame mapped to each region of the projected frame may be derived.

In FIGS. 8, (b) and 8 (c) illustrate examples of mapping each region of the projected frame is mapped to a region of the packed frame. Referring to (b) of FIG. 8, the 360-degree video data may be projected onto a 2D image (or frame) according to a panoramic projection scheme. Top, middle, and bottom regions of the projected frame may be rearranged as shown in the right figure via region-wise packing. Here, the top region may represent a top region of a panorama on the 2D image, the middle region may represent a middle region of the panorama on the 2D image, and the bottom region may represent a bottom region of the panorama on the 2D image. Referring to (c) of FIG. 8, the 360-degree video data may be projected onto a 2D image (or frame) according to a cubic projection scheme. Front, back, top, bottom, right, and left regions of the projected frame may be rearranged as shown in the right figure via region-wise packing. Here, the front region may represent a front region of a cube on the 2D image, and the back region may represent a back region of the cube on the 2D image. The top region may represent a top region of the cube on the 2D image, and the bottom region may represent a bottom region of the cube on the 2D image. The right region may represent a right region of the cube on the 2D image, and the left region may represent a left region of the cube on the 2D image.

In FIG. 8, (d) illustrates various 3D projection formats for projecting the 360-degree video data. Referring to (d) of FIG. 8, the 3D projection formats may include a tetrahedron, a cube, an octahedron, a dodecahedron, and an icosahedron. 2D projections shown in (d) of FIG. 8 may represent projected frames corresponding to 2D images resulting from the projection of 360-degree video data according to the 3D projection formats.

The foregoing projection formats are provided for illustrative purposes, and some or all of the following various projection formats (or projection schemes) may be used according to the present invention. A projection format used for a 360-degree video may be indicated, for example, through a projection format field of metadata.

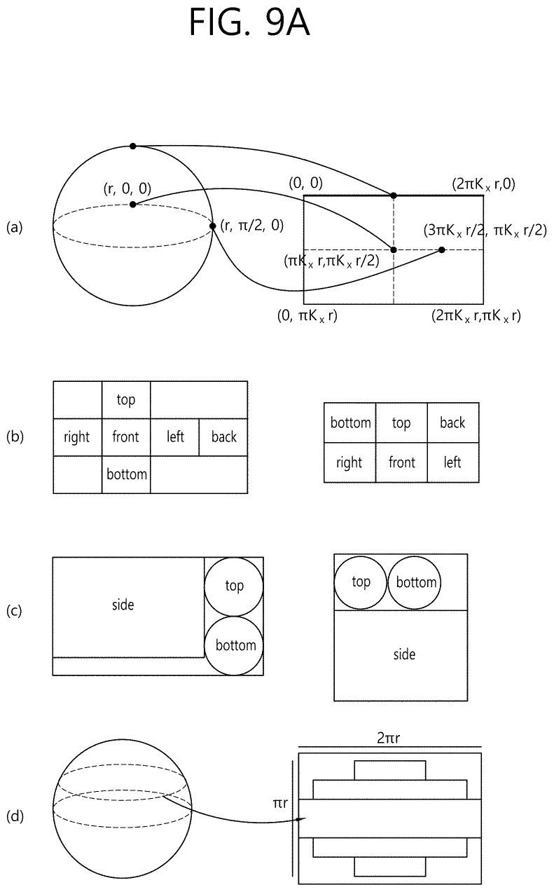

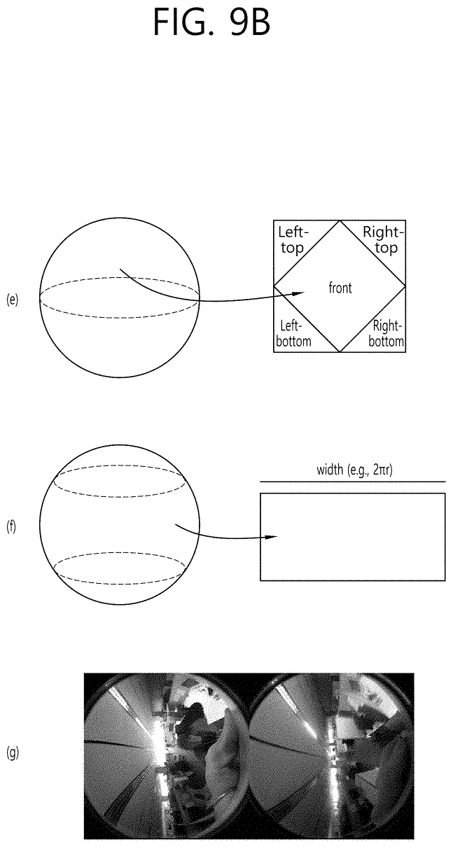

FIG. 9A and FIG. 9B illustrate projection formats according to the present invention.

In FIG. 9A, (a) illustrates an equirectangular projection format. When the equirectangular projection format is used, a point (r, θ₀, 0), that is, θ=θ₀ and φ=0, on the spherical surface may be mapped to a center pixel of a 2D image. Also, it may be assumed that a principal point of a front camera is a point (r, 0, 0) on the spherical surface, and φ₀=0. Accordingly, a converted value (x, y) on the XY coordinate system may be converted into a pixel (X, Y) on the 2D image by the following equation.

X=Kₓ*x+Xₒ=Kₓ*(θ−θ₀)*r+Xₒ

Y=−K_{y}*y−Yₒ [Equation 1]

When a top left pixel of the 2D image is positioned at (0, 0) on the XY coordinate system, an offset for the x-axis and an offset for the y-axis may be represented by the following equation.

Xₒ=Kₓ*π*r

Yₒ=−K_{y}*π/2*r [Equation 2]

Using these offsets, the equation for conversion onto the XY coordinate system may be modified as follows.

X=Kₓx+Xₒ=Kₓ*(π+θ−θ₀)*r

Y=−K_{y}y−Yₒ=K_{y}*(π/2−φ)*r [Equation 3]

For example, when θ₀=0, that is, when the center pixel of the 2D image indicates data corresponding to θ=0 on the spherical surface, the spherical surface may be mapped to an area defined by width=2Kₓπr and height=Kₓπr relative to (0, 0) on the 2D image. Data corresponding to φ=π/2 on the spherical surface may be mapped to an entire top side on the 2D image. Further, data corresponding to (r, π/2, 0) on the spherical surface may be mapped to a point (3πKₓr/2, πKₓ r/2) on the 2D image.

A reception side may re-project 360-degree video data on a 2D image onto a spherical surface, which may be represented by the following equation for conversion.

θ=θ₀+X/Kₓ*r−π

φ=π/2−Y/K_{y}*r [Equation 4]

For example, a pixel defined by XY coordinates (Kₓπr, 0) on the 2D image may be re-projected into a point defined by θ=θ₀ and φ=π/2 on the spherical surface.

In FIG. 9A, (b) illustrates a cubic projection format. For example, stitched 360-degree video data may be represented on a spherical surface. A projection processor may divide the 360-degree video data in a cubic shape and may project the 360-degree video data onto a 2D image. The 360-degree video data on the spherical surface may be projected on the 2D image corresponding to each face of a cube as shown in the left figure or the right figure in (b) of FIG. 9A.

In FIG. 9A, (c) illustrates a cylindrical projection format. Assuming that stitched 360-degree video data may be represented on a spherical surface, the projection processor may divide the 360-degree video data in a cylindrical shape and may project the 360-degree video data onto a 2D image. The 360-degree video data on the spherical surface may be projected on the 2D image corresponding to a side face, a top face, and a bottom face of a cylinder as shown in the left figure or the right figure in (b) of FIG. 9A.

In FIG. 9A, (d) illustrates a tile-based projection format. When the tile-based projection scheme is used, the projection processor may divide 360-degree video data on a spherical surface into one or more subareas to be projected onto a 2D image as shown in (d) of FIG. 9A. The subareas may be referred to as tiles.

In FIG. 9B, (e) illustrates a pyramid projection format. Assuming that stitched 360-degree video data may be represented on a spherical surface, the projection processor may view the 360-degree video data as a pyramid shape and may divide the 360-degree video data into faces to be projected onto a 2D image. The 360-degree video data on the spherical surface may be projected on the 2D image corresponding to a front face of a pyramid and four side faces of the pyramid including a left-top, left-bottom, right-top, and right-bottom faces as shown in the left figure or the right figure in (e) of FIG. 9B. Herein, the bottom surface may be an area including data acquired by a camera that faces the front surface. Here, the front face may be a region including data acquired by a front camera

In FIG. 9B, (f) illustrates a panoramic projection format. When the panoramic projection format is used, the projection processor may project only a side face of 360-degree video data on a spherical surface onto a 2D image as shown in (f) of FIG. 9B. This scheme may be the same as the cylindrical projection scheme except that there are no top and bottom faces.

According to the embodiment of the present invention, projection may be performed without stitching. In FIG. 9B, (g) illustrates a case where projection is performed without stitching. When projecting is performed without stitching, the projection processor may project 360-degree video data onto a 2D image as it is as shown in (g) of FIG. 9. In this case, without stitching, images acquired from respective cameras may be projected on a 2D image as it is.

Referring to (g) of FIG. 9B, two images may be projected onto a 2D image without stitching. Each image may be a fish-eye image acquired through each sensor of a spherical camera (or a fish-eye camera). As described above, a reception side may stitch image data acquired by camera sensors and may map the stitched image data onto a spherical surface, thereby rendering a spherical video, that is, a 360-degree video.

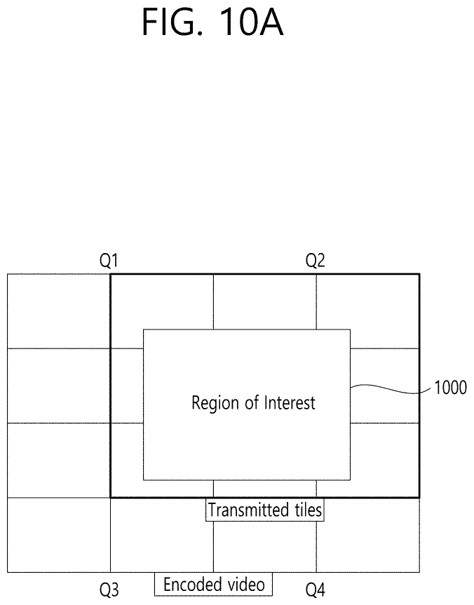

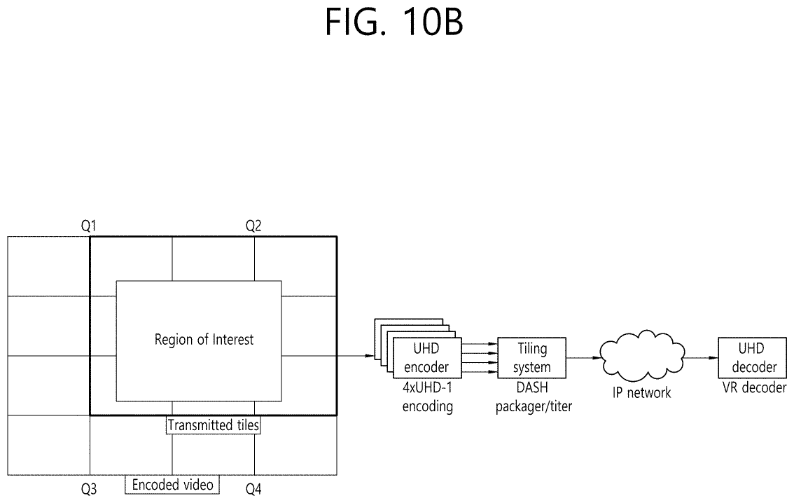

FIG. 10A and FIG. 10B illustrate a tile according to an embodiment of the present invention.

360-degree video data projected onto a 2D image or 360-degree video data subjected to up to region-wise packing may be divided into one or more tiles. FIG. 10a shows that one 2D image is divided into 16 tiles. Here, as described above, the 2D image may be a projected frame or a packed frame. In another embodiment of the 360-degree video transmission apparatus according to the present invention, the data encoder may independently encode each tile.

Region-wise packing described above and tiling may be distinguished. Region-wise packing described above may refer to a process of dividing 360-degree video data projected on a 2D image into regions and processing the divided regions in order to improve coding efficiency or to adjust resolutions. Tiling may refer to a process in which a data encoder divides a projected or packed frame into tiles and independently encodes each tile. When a 360-degree video is provided, a user does not consume all parts of the 360-degree video at the same time. Tiling may allow the user to transmit only a tile corresponding to an important part or a certain part, such as a viewport currently viewed by the user, to a reception side or to consume the tile with a limited bandwidth. Tiling enables efficient utilization of the limited bandwidth and makes it possible for the reception side to reduce operation loads as compared with the case of processing the entire 360-degree video data at one time.

Since a region and a tile are distinguished, these two areas do not need to be the same. In an embodiment, however, a region and a tile may refer to the same area. In an embodiment, when region-wise packing is performed in accordance with a tile, a region and a tile may be the same. Further, in an embodiment where each face and each region are the same according to the projection scheme, each face, each region, and each tile may refer to the same area according to the projection scheme. Depending on the context, a region may also be referred to as a VR region, and a tile may also be referred to as a tile region.

A region of interest (ROI) may refer to an area of interest from users proposed by a 360-degree content provider. When producing a 360-degree video, a 360-degree content provider may produce a 360-degree video in consideration of a particular area in which users are interested. In an embodiment, the ROI may correspond to an area in which an important part of the content of a 360-degree video is reproduced.

In another embodiment of the 360-degree video transmission/reception apparatus according to the present invention, the feedback processor of the reception side may extract and collect viewport information and may transmit the viewport information to the feedback processor of the transmission side. In this process, the viewport information may be transmitted using network interfaces of both sides. FIG. 10A shows a viewport (1000) in the 2D image. Here, the viewport may extend over nine tiles in the 2D image.

In this case, the 360-degree video transmission apparatus may further include a tiling system. In an embodiment, the tiling system may be located after the data encoder (in FIG. 10B), may be included in the data encoder or the transmission processor described above, or may be included as a separate internal/external element in the 360-degree video transmission apparatus.

The tiling system may receive the viewport information from the feedback processor of the transmission side. The tiling system may selectively transmit only a tile including a viewport area. Only nine tiles including the viewport area (1000) among a total of 16 tiles in the 2D image shown in FIG. 10A may be transmitted. Here, the tiling system may transmit the tiles in a unicast manner via a broadband, because the viewport area varies depending on the user.

In this case, the feedback processor of the transmission side may transmit the viewport information to the data encoder. The data encoder may encode the tiles including the viewport area with higher quality than that of other tiles.

Further, the feedback processor of the transmission side may transmit the viewport information to the metadata processor. The metadata processor may transmit metadata related to the viewport area to each internal element of the 360-degree video transmission apparatus or may include the metadata in 360-degree video-related metadata.

By using this tiling method, it is possible to save transmission bandwidths and to differently perform processing for each tile, thereby achieving efficient data processing/transmission.

The foregoing embodiments related to the viewport area may be similarly applied to specific areas other than the viewport area. For example, processing performed on the viewport area may be equally performed on an area determined as an area in which users are interested through the aforementioned gaze analysis, an ROI, and an area (initial viewpoint) that is reproduced first when a user views a 360-degree video through a VR display.

In another embodiment of the 360-degree video transmission apparatus according to the present invention, the transmission processor may perform transmission processing differently for each tile. The transmission processor may apply different transmission parameters (modulation orders or code rates) to each tile such that robustness of data delivered via each tile is changed.

Here, the feedback processor of the transmission side may deliver feedback information, received from the 360-degree video reception apparatus, to the transmission processor, and the transmission processor may perform transmission processing differentiated for tiles. For example, the feedback processor of the transmission side may deliver the viewport information, received from the reception side, to the transmission processor. The transmission processor may perform transmission processing on tiles including the viewport area to have higher robustness than that of other tiles.

Meanwhile, the above-described 360 video related metadata may include diverse metadata one the 360 video. The 360 video related metadata may also be referred to as 360 video related signaling information. The 360 video related metadata may be included in a separate signaling table and then transmitted or may be included in a DASH MPD and then transmitted or may be included in a box format in a file format, such as ISOBMFF, and so on, and then delivered. In case the 360 video related metadata is included in a box format, the metadata is included in multiple levels, such as file, fragment, track, sample entry, sample, and so on, and, therefore, metadata for the data of the corresponding level may be included. According to the exemplary embodiment, part of the metadata that will be described later on may be configured as a signaling table and then delivered, and the remaining part of the metadata may be included in a box or track format within the file format. According to the exemplary embodiment, the 360 video related metadata according to the present invention may include default metadata related to a projection format, metadata related to stereoscopic, metadata related to Initial View/Initial Viewpoint, metadata related to ROI, metadata related to the Field of View (FOV), and/or metadata related to the cropped region. According to the exemplary embodiment, in addition to the above-described metadata, the 360 video related metadata may further include additional metadata. The exemplary embodiment of the 360 related metadata according to the present invention may correspond to a format included at least one or more of the above-described default metadata, stereoscopic related metadata, initial viewpoint related metadata, ROI related metadata, FOV related metadata, cropped region related metadata, and/or metadata that may be added later on. The exemplary embodiment of the 360 related metadata according to the present invention may be diversely configured in accordance with the number of cases of the detailed metadata being included in each exemplary embodiment. For example, the 360 video related metadata may include information related to the orientation of a projection structure of the 360 video, coverage information of the 360 video, and/or information related to 360 video acquired from the fish-eye camera.

The following table indicates metadata related to 360-video according to an exemplary embodiment of the present invention. the metadata may be stored in the form of a box, or the metadata may be included in an SEI message, and so on, within a video stream, such as HEVC, AVC, and so on.

TABLE 1
aligned(8) class OMVideoConfigurationBox extends FullBox(‘omvc’,
version=0, 0) {
...

| | | |
|---|---|---|
| unsigned | int(8) | projection_format; |
| unsigned | int(8) | projection_geometry; |
| unsigned | int(1) | is_full_spherical; |
| unsigned | int(1) | is_not_centered; |
| unsigned | int(1) | orientation_flag, |
| unsigned | int(1) | content_fov_flag; |
| unsigned | int(1) | region_info_flag; |
| unsigned | int(1) | packing_flag; |

...

if(!is_full_spherical){

| | |
|---|---|
| signed int(16) | min_pitch; |
| signed int(16) | max_pitch; |
| signed int(16) | min_yaw; |
| signed int(16) | max_yaw; |

}
if(is_not_centered){

| | |
|---|---|
| signed int(16) | center_yaw; |
| signed int(16) | center_pitch; |
| signed int(16) | center_roll; |

}
if(orientation_flag){

| | |
|---|---|
| signed int(16) | global_orientation_yaw; |
| signed int(16) | global_orientation_pitch; |
| signed int(16) | global_orientation_roll; |

}
if(content_fov){

| | |
|---|---|
| unsigned int(16) | viewport_vfov; |
| unsigned int(16 ) | viewport_hfov; |

}
if(region_info_flag || packing_flag){

| | |
|---|---|
| unsigned int(8) | region_face_type; |

RegionGroupInfo(projection_format, projection_geometry,
region_face_type);

}

}

Referring to Table 1, a projection_format field may indicate a projection format that is applied when a 360-video image (omnidirectional video) is projected (or mapped) on a 2D image. For example, when a value of the projection_format field is equal to 0x01, this may indicate an equirectangular projection, when the value of the projection_format field is equal to 0x02, this may indicate a cube map projection, when the value of the projection_format field is equal to 0x03, this may indicate a segmented sphere projection, when the value of the projection_format field is equal to 0x04, this may indicate an octahedron projection, and when the value of the projection_format field is equal to 0x05, this may indicate an icosahedron projection. However, this is merely exemplary, and, therefore, in addition to the above-mentioned projection formats, other diverse projection formats and/or related layouts may be indicated by the projection_format field.

For example, the projection_format field may also indicate a detailed layout of a specific projection format. Herein, the layout may include a number of columns and rows being applied when performing image projection. For example, the projection_format field may indicate a 4*3 cube map projection, and this may indicate that the layout is configured of 4 columns and 3 rows when performing the image projection. Additionally, for example, the projection_format field may also indicate a 3*2 cube map projection.

A projection_geometry field may indicate the geometry (sphere, cube, icosahedron, octahedron, and so on) of a 3D model that is used for projecting the 360 video image on an image frame.

An is_full_spherical field corresponds to flag information that may indicate whether or not data corresponding to 360*180 is included in an active video area of the image frame. In case the value of this field is false (i.e., 0), this may indicate that the active video area includes data corresponding to an area being is smaller than 360*180.

In case the value of the is_full_spherical field is false, a min_pitch field, a max_pitch field, a min_yaw field, and a max_yaw field may respectively indicate minimum/maximum pitch values and minimum/maximum yaw values of an area being mapped to a sphere when rendering the video data that is included in the active video area.

An orientation_flag field corresponds to flag information indicating the presence or absence of orientation information of a capture coordinate of a sensor (camera, and so on) that captured the image based on a global coordinate.

A global_orientation_yaw field, a global_orientation_pitch field, and a global_orientation_roll field may respectively indicate a yaw value, a pitch value, and a roll value corresponding to the orientation of a capture coordinate of a sensor (camera, and so on) that captured the image based on a global coordinate. For example, the above-mentioned fields may respectively indicate a yaw value, a pitch value, and a roll value corresponding to the orientation of a front camera of the 360 camera.

A content_fov_flag field indicates flag information on the presence or absence of information on a field of view (FOV) of a viewport that was intended when producing the corresponding 360 video.

A viewport_vfov field and a viewport_hfov field may respectively indicate information on a recommended vertical field of view (FOV) and a recommended horizontal field of view (FOV) that were intended when producing the corresponding 360 video.

A region_info_flag field may correspond to flag information indicating the presence or absence of a detailed region of the active video area within the image frame.

A packing_flag field may indicate whether or not region-wise packing is applied to the video data included in the active video area within the image frame. In case a value of the corresponding field is equal to 1, this may indicate that region-wise packing is applied. Herein, a receiving device may determine whether or not the receiving device is capable of processing the data within the image frame by using the corresponding flag value. For example, in case of a receiving device that cannot support region-wise packing, if the value of the packing_flag field is true (i.e., 1), since it may be known that the corresponding image frame cannot be processed, appropriate processing may be performed accordingly.

A region_face_type field may indicate a face shape (or form) of each active video area within the image frame. For example, in case the cube map projection is applied, the region_face_type field may indicate a rectangular shape (or rectangle). And, in case the octahedron projection or icosahedron projection is applied, the region_face_type field may indicate a triangular shape (or triangle).

An is_not_centered field may indicate whether or not a center pixel of the active video area within the image frame is mapped to a point corresponding to yaw=0, pitch=0, roll=0 on a spherical surface, or the is_not_centered field may indicate the information shown in the following table in accordance with the projection_format values.

TABLE 2

| Projection format | Meaning |
|---|---|
| Equirectangular | This may indicate whether or not a center pixel |
| projection, segmented | of the active video area within the image |
| sphere projection | frame is mapped to a point corresponding to |
| | yaw = 0, pitch = 0, roll = 0 on |
| | a spherical surface. |
| Cube map projection, | This may indicate whether or not a center pixel |
| icosahedron projection, | of a front surface of the active video area |
| octahedron projection | within the image frame is mapped to a point |
| | corresponding to yaw = 0, pitch = 0, |
| | roll = 0 on a spherical surface. |
| Cylindrical | This may indicate whether or not a center pixel |
| projection | of a side surface of the active video area |
| | within the image frame is mapped to a point |
| | corresponding to yaw = 0, pitch = 0, |
| | roll = 0 on a spherical surface. |

A RegionGroupInfo field may include information shown in the following table, and the receiving device may perform projection and/or region-wise packing by using the information included in the RegionGroupInfo field, and the receiving device may appropriately process the video data projected on the image frame.

TABLE 3
class RegionGroupInfo (unsigned int(8) projection format,

unsigned int(8) projection_geometry,
unsigned int(8) region_face_type) {

| | |
|---|---|
| unsigned int(8) | group_id; |
| unsigned int(4) | reserved=0; |
| unsigned int(4) | coding_dependency; |
| unsigned int(8) | num_regions; |

for (j=0; j<= num_regions; j++) {

| | |
|---|---|
| unsigned int(8) | region_id; // might be equal to an tile region identifier |
| unsigned int(16) | horizontal_offset; |
| unsigned int(16) | vertical_offset; |
| unsigned int(16) | region_width; |
| unsigned int(16) | region_height; |
| unsigned int(6) | resvered =0; |
| unsigned int(1) | is_sub_regions; |
| unsigned int (1) | is_rotation; |

if(is_rotation){

| | |
|---|---|
| unsigned int(8) | region_rotation; |

}
if(projection_geometry == ‘0’) { //sphere −> ERP, SSP

| | |
|---|---|
| signed int(16) | min_region_pitch ; |
| signed int(16) | max_region_pitch ; |
| signed int(16) | min_region_yaw ; |
| signed int(16) | max_region_yaw ; |
| signed int(16) | min_region_roll ; |
| signed int(16) | max_region_roll ; |

| }else if(projection_geometry == ‘1’ \|\| | | // rectangular : cubic, TSP, cubic |
|---|---|---|
| projection | | |
| | projection_geometry == ‘2’ \|\| | // cylinder |
| | projection_geometry == ‘3’) | // triangle-based geometry : ISP, OHP |

| | |
|---|---|
| unsinged int(8) | face_id; |

if(is_sub_regions){

unsigned int(8)num_subregions;
for(int i=0; I < num_subregions; I++){

| | |
|---|---|
| unsigned int(16) | sub_region_horizental_offset ; |
| unsigned int(16) | sub_region_vertical_offset ; |
| unsigned int(16) | sub_region_width ; |
| unsigned int(16) | sub_region_height ; |
| unsigned int(16) | min_sub_region_yaw ; |
| unsigned int(16) | max_sub_region_yaw ; |
| unsigned int(16) | min_sub_region_pitch ; |
| unsigned int(16) | max_sub_region_pitch; |
| unsigned int(16) | min_sub_region_roll; |
| unsigned int(16) | max_sub_region_roll; |

}

}

}

}

}

Referring to FIG. 3, a min_region_pitch field may indicate a minimum pitch value of an area having the corresponding region be re-projected on a 3D space. In other words, this field may indicate a minimum pitch value of data within a spherical surface being mapped to the corresponding region within a spherical coordinate or global coordinate of a capture space.

A max_region_pitch field may indicate a maximum pitch value of an area having the corresponding region be re-projected on a 3D space. In other words, this field may indicate a maximum pitch value of data within a spherical surface being mapped to the corresponding region within a spherical coordinate or global coordinate of a capture space.

A min_region_yaw field may indicate a minimum yaw value of an area having the corresponding region be re-projected on a 3D space. In other words, this field may indicate a minimum yaw value of data within a spherical surface being mapped to the corresponding region within a spherical coordinate or global coordinate of a capture space.

A max_region_yaw field may indicate a maximum yaw value of an area having the corresponding region be re-projected on a 3D space. In other words, this field may indicate a maximum yaw value of data within a spherical surface being mapped to the corresponding region within a spherical coordinate or global coordinate of a capture space.

A min_region_roll field may indicate a minimum roll value of an area having the corresponding region be re-projected on a 3D space. In other words, this field may indicate a minimum roll value of data within a spherical surface being mapped to the corresponding region within a spherical coordinate or global coordinate of a capture space.

A max_region_roll field may indicate a maximum roll value of an area having the corresponding region be re-projected on a 3D space. In other words, this field may indicate a maximum roll value of data within a spherical surface being mapped to the corresponding region within a spherical coordinate or global coordinate of a capture space.

A face_id field may indicate an identifier of a face within a projection geometry that is matched with the corresponding region. This field may be differently indicated in accordance with the projection geometry. For example, if the projection geometry is a cube shape, the face_id field may indicate the identifier of each cube face. And, if the projection geometry is an octahedron shape, the face_id field may indicate the identifier of each of the above-described octahedron faces. And, if the projection geometry is an icosahedron shape, the face_id field may indicate the identifier of each of the above-described icosahedron faces.

A num_subregions field may indicate a number of subregions being included in the corresponding region.

A min_sub_region_yaw field and a max_sub_region_yaw field may respectively indicate minimum and maximum yaw values of an area having the corresponding subregion be re-projected on a 3D space. In other words, these fields may respectively indicate minimum/maximum yaw values of data within a spherical surface being mapped to the corresponding subregion within a spherical coordinate or global coordinate of a capture space.

A min_sub_region_pitch field and a max_sub_region_pitch field may respectively indicate minimum and maximum pitch values of an area having the corresponding subregion be re-projected on a 3D space. In other words, these fields may respectively indicate minimum/maximum pitch values of data within a spherical surface being mapped to the corresponding subregion within a spherical coordinate or global coordinate of a capture space.

A min_sub_region_roll field and a max_sub_region_roll field may respectively indicate minimum and maximum roll values of an area having the corresponding subregion be re-projected on a 3D space. In other words, these fields may respectively indicate minimum/maximum roll values of data within a spherical surface being mapped to the corresponding subregion within a spherical coordinate or global coordinate of a capture space.

Meanwhile, a 360 video stream may be divided (or segmented) and stored per region within a single file via one track or multiple tracks. For example, an active video area of a 360 video image frame may be divided (or segmented) per region and may then be stored in one track or multiple tracks, or an active video area of a 360 video image frame may be divided (or segmented) into one or more sample groups and may then be stored in one track. In case one video stream is divided and stored via multiple tracks, one track may include one sample group. In this case, for example, region-related information shown below may be included in a sample group entry, and so on, within a file.

TABLE 4
...

unsigned int(8) region_description_type; //3D, 2D coordinate, face_id
unsigned int(16) group_id;
unsigned int(16) vr_region_id;
if(region_description_type == ‘0’){

| | |
|---|---|
| signed int(16) | min_region_pitch ; |
| signed int(16) | max_region_pitch ; |
| signed int(16) | min_region_yaw ; |
| signed int(16) | max_region_yaw ; |
| signed int(16) | min_region_roll ; |
| signed int(16) | max_region_roll ; |

else if (region_description_type == ‘1’){// 2D coordinate

| | |
|---|---|
| unsigned int(16) | horizontal_offset; |
| unsigned int(16) | vertical_offset; |
| unsigned int(16) | region_width; |
| unsigned int(16) | region_height; |

} else if (region_description_type == ‘2’) { // rectangular : cubic, TSP, cubic projection

unsinged int(8) face_id;

}

...

A region_description_type field may indicate a description format of a region. According to an exemplary embodiment, the region_description_type field may have the following values. However, the value that will be presented below are merely exemplary, and, therefore, the information being mapped to the respective values may vary. 0x00 may indicate a spherical coordinate. This may be expressed as yaw, pitch, and roll values. 0x01 may indicate a 2D coordinate. This may be expressed as information indicating a rectangular area within an image coordinate. 0x02 may indicate a face_id. This may indicate an identifier of a surface configuring a 3D geometry that is used when projecting a 360 video on an image frame.

A vr_region_id field may indicate an identifier for a region of a 360 video being included in a tile. This field may correspond to the region_id field of the above-described RegionGroupInfo field.

A min_region_pitch field, a max_region_pitch field, a min_region_yaw field, a max_region_yaw field, a min_region_roll field, and a max_region_roll field may indicate a specific area within a capture coordinate or global coordinate based spherical surface being mapped to a region of a 360 video being included in a tile. The min_region_pitch field, the max_region_pitch field, the min_region_yaw field, the max_region_yaw field, the min_region_roll field, and the max_region_roll field may be included in a case where the value of the region_description_type field indicates ‘0’.

A horizontal_offset field, a vertical_offset field, a region_width field, and a region_height field may indicate a specific rectangular area within an active video area of an image frame being mapped to a region of the 360 video being included in a tile. The horizontal_offset field, the vertical_offset field, the region_width field, and the region_height field may be included in a case where the value of the region_description_type field is equal to ‘1’.

A face_id field may indicate an identifier of a face configuring a 3D geometry that is used when projecting a 360 video being mapped to a region of a 360 video included in a tile. For example, in case cube map projection is applied, this filed may indicate an identifier of a cube face, such as a cube front, and so on. And, in case an icosahedron projection is applied, this field may be expressed as a face identifier of an icosahedron. The face_id field may be included in a case where the value of the region_description_type field is equal to ‘2’.

Meanwhile, as described above, in case a 360 video stream is encoded/decoded by using HEVC tiling, and so on, one tile may include a specific area of the 360 video. Such tiles may be included in one or more tracks within a file. Based on this structure, in order to support viewport-dependent processing, for example, information on an area of a 360 video being associated with a tile may be included in a file format, as described below.

TABLE 5

| | |
|---|---|
| unsigned int (16) | tile_group_id; |
| unsigned int (8) | num_vr_regions; |

for(i=1; i <= num_vr_regions; i++){

| | |
|---|---|
| unsigned int(8) | vr_region_id; |
| unsigned int(4) | region_description_type; |

| | |
|---|---|
| unsigned int(3) | reserved; |
| unsigned int(1) | full_region_flag; |

if(region_description_type == ‘0’){

| | |
|---|---|
| signed int(16) | min_region_pitch ; |
| signed int(16) | max_region_pitch ; |
| signed int(16) | min_region_yaw ; |
| signed int(16) | max_region_yaw ; |
| signed int(16) | min_region_roll ; |
| signed int(16) | max_region_roll ; |

else if (region_description_type == ‘1’ ){// 2D coordinate

| | |
|---|---|
| unsigned int(16) | horizontal_offset; |
| unsigned int(16) | vertical_offset; |
| unsigned int(16) | region_width; |
| unsigned int(16) | region_height; |

} else if (region_description_type == ‘2’) { // rectangular : cubic, TSP, cubic
projection

| | |
|---|---|
| unsinged int(8) | face_id; |

}

}

A tile_group_id field may indicate an identifier of a tile.

A num_vr_regions field may indicate a number of a regions of a 360 video being included in a tile.

A region_description_type field may indicate a description format of a region. According to an exemplary embodiment, the region_description_type field may have the following values. However, the value that will be presented below are merely exemplary, and, therefore, the information being mapped to the respective values may vary. 0x00 may indicate a spherical coordinate. This may be expressed as yaw, pitch, and roll values. 0x01 may indicate a 2D coordinate. This may be expressed as information indicating a rectangular area within an image coordinate. 0x02 may indicate a face_id. This may indicate an identifier of a surface configuring a 3D geometry that is used when projecting a 360 video on an image frame.

A vr_region_id field may indicate an identifier for a region of a 360 video being included in a tile. This field may correspond to the region_id field of the above-described RegionGroupInfo field.

A min_region_pitch field, a max_region_pitch field, a min_region_yaw field, a max_region_yaw field, a min_region_roll field, and a max_region_roll field may indicate a specific area within a capture coordinate or global coordinate based spherical surface being mapped to a region of a 360 video being included in a tile. The min_region_pitch field, the max_region_pitch field, the min_region_yaw field, the max_region_yaw field, the min_region_roll field, and the max_region_roll field may be included in a case where the value of the region_description_type field indicates ‘0’.

A horizontal_offset field, a vertical_offset field, a region_width field, and a region_height field may indicate a specific rectangular area within an active video area of an image frame being mapped to a region of the 360 video being included in a tile. The horizontal_offset field, the vertical_offset field, the region_width field, and the region_height field may be included in a case where the value of the region_description_type field is equal to ‘1’.

A face_id field may indicate an identifier of a face configuring a 3D geometry that is used when projecting a 360 video being mapped to a region of a 360 video included in a tile. For example, in case cube map projection is applied, this filed may indicate an identifier of a cube face, such as a cube front, and so on. And, in case an icosahedron projection is applied, this field may be expressed as a face identifier of an icosahedron. The face_id field may be included in a case where the value of the region_description_type field is equal to ‘2’.

Meanwhile, in case of a 360 video, a user may freely relocate the viewport. For example, the user may freely relocate the viewport within the entire area, or the user may freely relocate the viewport within an angular range of 360*180. In order to determine a viewport that is (initially) shown to the user as a scene changes, information on a point within a sphere being mapped to a center point of a viewpoint that is shown in a head mount display (HMD), and so on, of the user may be signaled as shown below in the following example.

TABLE 6

| | | |
|---|---|---|
| signed | int(16) | initial_view_yaw; |
| signed | int(16) | initial_view_pitch; |
| signed | int(16) | initial_view_roll; |

An initial_view_yaw field, an initial_view_pitch field, and an initial_view_roll field may respectively indicate yaw, pitch, and roll values of a point within a sphere being mapped to a center point of the viewport being (initially) shown in the HMD of the user.

The information indicates a point within a sphere being mapped to a center point of the viewport of the user, and the receiving device (or receiver) determines the user's orientation from the entire area or 360*180 area by using the corresponding information. Thus, the (initial) viewport being shown to the user may be finally determined in accordance with a vertical FOV and horizontal FOV of the HMD. When rendering a 360 audio by using the above-described information, the point within the sphere that is expressed by using the corresponding information may be assumed as the orientation of the initial view of the user. And, thereafter, the 360 audio may be rendered based on this assumption.

The information may be updated in accordance with a change in the scene or a change in time. For this, a sample group entry being associated with a video/audio track or a separate timed metadata track, and so on, may be included in a box within a file format. Furthermore, this may also be stored as a separate file.

Meanwhile, in order to provide 360 video services, the following 360 image formats may be signaled.

A 360 video (or omnidirectional video, omnidirectional image) may be stored in an image item format within a file, as disclosed in ISO/IEC 23008-12. ProjectionFormatProperty information may exist for the 360 video. Additionally, in case the 360 video includes stereoscopic contents, FramePackingProperty information may exist for the image item. Additionally, in case the image item includes a packed picture, RegionWisePackingProperty information may exist for the image item. As described above, the packed picture may be generated from a projected picture via region-wise packing. The information may be included in a box within a file format, or the information may be included as data of a separate track within the file. Alternatively, apart from the above-mentioned information, additional information that will be described later on may also be included in a box within a file format or may be included as data of a separate track within the file and may then be additionally signaled.

More specifically, for example, the FramePackingProperty information may be referred to as Frame packing item property information, and, for example, this may include the following formats and/or definitions.

TABLE 7

| | |
|---|---|
| Box type: | ‘stvi’ |
| Property type: | Descriptive item property |
| Container: | ItemPropertyContainerBox |

| | |
|---|---|
| Mandatory (per an item): | No |
| Quantity (per an item): | Zero or one |

FramePackingProperty indicates that the reconstructed image contains a
representation of two spatially packed constituent pictures.
essential shall be equal to 1 for a ‘stvi’ item property.

Herein, the FramePackingProperty information may include syntaxes that are the same as the syntaxes of the StereoVideoBox, which is disclosed in ISO/IEC 14496-12.

The semantics of the syntax elements of the FramePackingProperty information may be the same as the semantics for the syntax elements of the StereoVideoBox.

The ProjectionFormatProperty information may be referred to as projection format item property information, and, for example, this may include the following formats and/or definitions.

TABLE 8

Box type: ‘prfr’
Property type: Descriptive item property
Container: ItemPropertyContainerBox
Mandatory (per an item): No
Quantity (per an item): Zero or one
ProjectionFormatProperty indicates that the
omnidirectional projection format of the image.
When present, ‘prfr’ item property shall appear
before ‘stvi’ and ‘rwpk’ item properties, if any.
When ‘prfr’ is present, the reconstructed image
represents a packed picture that has been generated
as indicated in FIG. 42 and FIG. 43 for a monoscopic
and stereoscopic image, respectively.
The format of the projected monoscopic pictures is
indicated with the ProjectionFormatProperty.
For stereoscopic video, the frame packing arrangement
of the projected left and right pictures is
indicated with the FramePackingProperty. The absence
of FramePackingProperty indicates that the
content of the track is monoscopic.
Optional region-wise packing is indicated with the
RegionWisePackingProperty. The absence of
RegionWisePackingProperty indicates that no
region-wise packing is applied.
essential shall be equal to 1 for a ‘prfr’ item property.

Herein, for example, the FramePackingProperty information may have the following syntax.

TABLE 9

```
aligned(8) class ProjectionFormatProperty
extends ItemFullProperty(‘prfr’, version = 0, flags = 0) {
            ProjectionFormatStruct( );
}
aligned(8) class ProjectionFormatStruct( ) {
            bit(3) reserved = 0;
            unsigned int(5) projection_type;
}
```

Herein, each configuration element of the syntax may be referred to as a syntax element (this will hereinafter be equally applied to the following description), and the semantics for the FramePackingProperty information will include the following fields.

A projection_type field (syntax element) may indicate a particular mapping from rectangular decoder picture output samples to a spherical coordinate system. For example, when the value of the projection_type field value is equal to 0, this may indicate an equirectangular projection. The remaining values of the projection_type field may be reserved. Alternatively, as another example, the projection_type field may include the same values and content as disclosed in the projection_format field of the above-described Table 1.

The RegionWisePackingProperty information may be referred to as region-wise packing item property information, and, for example, this may include the following formats and/or definitions.

TABLE 10
Box type: ‘rwpk’
Property type: Descriptive item property
Container: ItemPropertyContainerBox
Mandatory (per an item): No
Quantity (per an item): Zero or one
RegionWisePackingProperty is used to indicate that decoding pictures are
packed region-wise and require unpacking prior to displaying. When
present, ‘rwpk’ item property shall appear after ‘prfr’ and ‘rwpk’
item properties, if any.
essential shall be equal to 1 for a ‘rwpk’ item property.

Herein, for example, the RegionWisePackingProperty information may have the following syntax.

```
TABLE 11
aligned(8) class RegionWisePackingProperty
extends ItemFullProperty(‘rwpk’, version = 0, flags = 0) {
          RegionWisePackingStruct( );
}
aligned(8) class RegionWisePackingStruct {
          unsigned int(8) num_regions;
          unsigned int(16) proj_picture_width;
          unsigned int(16) proj_picture_height;
          for (i = 0; i < num_regions; i++) {
                    bit(3) reserved = 0;
                    unsigned int(1) guard_band_flag[i];
                    unsigned int(4) packing_type[i];
                    if (guard_band_flag[i]) {
                              unsigned int(8) left_gb_width[i];
                              unsigned int(8) right_gb_width[i];
                              unsigned int(8) top_gb_height[i];
                              unsigned int(8)
                              bottom_gb_height[i];
                              unsigned int(1)
                              gb_not_used_for_pred_flag[i];
                              unsigned int(3) gb_type[i];
                              bit(4) reserved = 0;
                    }
                    if (packing_type[i] == 0)
                              RectRegionPacking(i);
          }
}
aligned(8) class RectRegionPacking(i) {
          unsigned int(16) proj_reg_width[i];
          unsigned int(16) proj_reg_height[i];
          unsigned int(16) proj_reg_top[i];
          unsigned int(16) proj_reg_left[i];
          unsigned int(3) transform_type[i];
          bit(5) reserved = 0;
          unsigned int(16) packed_reg_width[i];
          unsigned int(16) packed_reg_height[i];
          unsigned int(16) packed_reg_top[i];
          unsigned int(16) packed_reg_left[i];
}
```

Herein, the semantics for (each syntax element) of the RegionWisePackingProperty information may include the following fields.

A num_regions field (syntax element) may indicate a number of packed regions. The 0 value of the num_regions field may be reserved.

A proj_picture_width field and a proj_picture_height field may respectively indicate a width and height of a projected picture. The value of the proj_picture_width field and the value of the proj_picture_height field may be set to be greater than 0.

When a guard_band_flag[i] field is equal to 0, this may indicate that the i^{th} region does not have a guard band, when the guard_band_flag[i] field equal to 1, this may indicate that the i^{th} region has a guard band.

A packing_type[i] field may indicate a type of region-wise packing. When the packing_type[i] field is equal to 0, this may indicate rectangular region-wise packing. Other values may be reserved.

A left_gb_width[i] field indicates a width of the guard band on a left side of the i^{th} region. In this case, the left_gb_width[i] field may indicate the width in units of two luma samples.

A right_gb_width[i] field indicates the width of the guard band on a right side of the i^{th} region. In this case, the right_gb_width[i] field may the width in units of two luma samples.

A top_gb_width[i] field indicates the width of the guard band on an upper (or top) side of the i^{th} region. In this case, the top_gb_width[i] field may indicate the width in units of two luma samples.

A bottom_gb_width[i] field indicates the width of the guard band on a lower (or bottom) side of the below the i^{th} region. In this case, the bottom_gb_width[i] field may indicate the width in units of two luma samples.

When the value of the guard_band_flag[i] is equal to 1, the left_gb_width[i] field, the right_gb_width[i] field, the top_gb_width[i] field, or the bottom_gb_width[i] field shall be set to be greater than 0.

The i^{th} region (and guard band(s) of the i^{th} region), if any, shall not overlap with any other region (and guard bands of the other regions).

When the value of a gb_not_used_for_pred_flag[i] field is equal to 0, this may indicate that the guard bands may or may not be used in the inter prediction process. When the value of the gb_not_used_for_pred_flag[i] field is equal to 1, this may indicate that the sample values of the guard bands are not used in the inter prediction process.

For reference, in case the value of the gb_not_used_for_pred_flag[i] field is equal to 1, even if decoded pictures are used later on for referential purposes when performing inter prediction for the decoding of pictures, the sample values of the guard bands within the decoded pictures can be rewritten. For example, the content of a region may be seamlessly expanded to its guard band with decoded and re-projected samples of another region.

A gb_type[i] field may indicate the type of the guard bands for the i^{th} region as described below in the following example. When the value of the gb_type[i] field is equal to 0, this may indicate that the content of the guard bands in relation to the content of the regions is unspecified. The value of the gb_type field shall not be set to 0, when the gb_not_used_for_pred_flag[i] field is equal to 0. When the value of the gb_type[i] field is equal to 1, this may indicate that that the content of the guard bands is sufficient for interpolation of sub-pixel values within the region and less than one pixel outside of the region boundary. For reference, the value 1 of the gb_type[i] field may be used when the boundary samples of a region have been copied horizontally or vertically to the guard band. The value 2 of the gb_type[i] field may indicate that the content of the guard bands represents actual image content at a quality that gradually changes from the picture quality of the region to the picture quality of a spherically adjacent region. The value 3 of the gb_type[i] field may indicate that the content of the guard bands represents actual image content at the picture quality of the region. Value of the gb_type[i] field that are greater than 3 may be reserved.

A proj_reg_width[i] field, a proj_reg_height[i] field, a proj_reg_top[i] field, and a proj_reg_left[i] field may indicate positions and sizes of a region within a projected picture. By using the proj_reg_width[i] field, the proj_reg_height[i] field, the proj_reg_top[i] field, and the proj_reg_left[i] field, a region may be indicated within a projected picture in units of pixels corresponding to width and height, such as proj_picture_width and proj_picture_height. Herein, the proj_picture_width and proj_picture_height may respectively indicate the width and height of the projected picture.

The proj_reg_width[i] field may indicate the width of the i^{th} region of the projected picture. The proj_reg_width[i] field may be set to be greater than 0.

The proj_reg_height[i] field may indicate the height of the i^{th} region of the projected picture. The proj_reg_height[i] field may be set to be greater than 0.

A proj_reg_top[i] field and a proj_reg_left[i] field may indicate a top sample row and a left-most sample column in the projected picture. The values may respectively be within a range from (0,0), inclusive, to (proj_picture_width, proj_picture_height), exclusive.

The proj_reg_width[i] field and the proj_reg_left[i] field may be limited (or restricted) so that proj_reg_width[i]+proj_reg_left[i] can be less than proj_picture_width. Additionally, the proj_reg_height[i] field and the proj_reg_top[i] field may be limited (or restricted) so that proj_reg_height[i]+proj_reg_top[i] can be less than proj_picture_height.

In case the projected picture corresponds to a stereoscopic picture, the proj_reg_width[i] field, the proj_reg_height[i] field, the proj_reg_top[i] field, and the proj_reg_left[i] field may be set so that a region, which is identified in the projected picture by the above-mentioned fields, can be located within a single constituent picture of the projected picture. Herein, a constituent picture may indicate a part corresponding to a single view of the stereoscopic picture.

A transform_type[i] field may indicate rotation and mirroring that are applied to the i^{th} region of the projected picture in order to map the corresponding region to the packed picture before encoding. In case the transform_type[i] field indicates both rotation and mirroring, rotation is applied after applying mirroring in the region-wise packing from the projected picture to the packed picture before encoding. More specifically, for example, the values and content of the transform_type[i] field may be as described below, and other value may be reserved.

TABLE 12

| Value of transform_type[i] | Transform type |
|---|---|
| 0 | no transform |
| 1 | mirroring horizontally |
| 2 | rotation by 180 degrees (counter-clockwise) |
| 3 | rotation by 180 degrees (counter-clockwise) |
| | after mirroring horizontally |
| 4 | rotation by 90 degrees (counter-clockwise) |
| | after mirroring horizontally |
| 5 | rotation by 90 degrees (counter-clockwise) |
| 6 | rotation by 270 degrees (counter-clockwise) |
| | after mirroring horizontally |
| 7 | rotation by 270 degrees (counter-clockwise) |

A packed_reg_width[i] field, a packed_reg_height[i] field, a packed_reg_top[i] field, and a packed_reg_left[i] field may respectively indicate a width, a height, a top sample row, and a left-most sample column of the region within the packed picture. For each value of i in the range of 0 to num_region−1, a rectangle that is derived by the packed_reg_width[i] field, the packed_reg_height[i] field, the packed_reg_top[i] field, and the packed_reg_left[i] field shall be non-overlapping with a rectangle that is indicated by a packed_reg_width[j] field, a packed_reg_height[j] field, a packed_reg_top[j]field, and a packed_reg_left[j] field for any value of j in the range of 0 to i−1.

Meanwhile, ProjectionOrientationProperty information may exist in an image item within a file. For example, in case the image item includes a projected (omnidirectional) picture, which is specified by a different orientation of the projection structure for global coordinate axes, the ProjectionOrientationProperty information may exist in the image item. More specifically, considering a coding efficiency, a transmitting device (or transmitter) may control the projection orientation so as to derive a (corrected) projected picture. Thereafter, the transmitting device may perform an encoding procedure based on the projected picture. After decoding the encoded picture, the receiving device (or receiver) may perform rendering of the decoded picture by changing the orientation based on the projection orientation. Thus, more efficient coding (intra prediction, inter prediction, and so on) may be performed.

More specifically, the ProjectionOrientationProperty information may be referred to as projection orientation item property information, and, for example, this may include the following formats and/or definitions.

TABLE 13
Box type: ‘pror’
Property type: Descriptive item property
Container: ItemPropertyContainerBox
Mandatory (per an item): No
Quantity (per an item): Zero or one
ProjectionOrientationProperty is used to indicate the yaw, pitch, and roll
angles, respectively, of the center point of the projected omnidirectional
picture when projected to the spherical surface. In the case of
stereoscopic omnidirectional video, the fields apply to each view
individually. The absence of ProjectionOrientationProperty indicates the
orientation_yaw, orientation_pitch, and orientation_roll
are all considered to be equal to 0.
essential shall be equal to 1 for a ‘pror’ item property.

The ProjectionOrientationProperty information may, for example, have the following syntaxes.

TABLE 14

```
aligned(8) class ProjectionOrientationProperty
extends ItemFullProperty(‘pror’, version = 0, flags = 0) {
        ProjectionOrientationBox( );
/*specified in clause 7.2.6 of OMAF DIS[1]*/
}
When the projection format is the equirectangular projection,
the fields in this box provides the yaw,
pitch, and roll angles, respectively, of the center point of the
projected picture when projected to the
spherical surface. In the case of stereoscopic omnidirectional
video, the fields apply to each view
individually. When the ProjectionOrientationBox is not
present, the field orientation_yaw,
orientation_pitch, and orientation_roll are all
considered to be equal to 0.
aligned(8) class ProjectionOrientationBox
extends FullBox(‘pror’, version = 0, flags) {
        signed int(32) orientation_yaw;
        signed int(32) orientation_pitch;
        signed int(32) orientation_roll;
}
```

Herein, the semantics for (each syntax element) of the ProjectionOrientationProperty information may include the following.

An orientation_yaw field, an orientation_pitch field, and an orientation_roll field may respectively indicate yaw, pitch, and roll angles of a center point of a projected picture, when the projected picture is projected to a spherical surface. These fields may, for example, respectively indicate the yaw, pitch, and roll angles in units of 2⁻¹⁶ degrees in relation to the global coordinate axes. The value of the orientation_yaw field may be within a range of −180*2¹⁶ to 180*2¹⁶−1, inclusive, and the value of the orientation_pitch field may be within a range of −90*2¹⁶ to 90*2¹⁶, inclusive, and the value of the orientation_roll field may be within a range of −180*2¹⁶ to 180*2¹⁶−1, inclusive.

Additionally, the InitialViewpointProperty information may exist in an image item within a file. More specifically, the InitialViewpointProperty information may be referred to as initial viewpoint item property information, and, for example, this may include the following formats and/or definitions.

TABLE 15

Box type: ‘iivo’
Property type: Descriptive item property
Container: ItemPropertyContainerBox
Mandatory (per an item): No
Quantity (per an item): Zero or one
InitialViewpointProperty indicates the initial viewport
orientation according to which the image should be
initially rendered to the user. In the absence of this
property the rendering should initially be towards
orientation (0, 0, 0) in (yaw, pitch, roll) relative to
the global coordinate axes.
For the syntax and semantics of InitialViewportProperty,
shape_type is inferred to be equal to 0,
dynamic_range_flag is inferred to be equal to 0,
static_hor_range is inferred to be equal to 0, and
static_ver_range is inferred to be equal to 0.

The InitialViewpointProperty information may, for example, have the following syntax.

TABLE 16

```
aligned(8) class InitialViewpointProperty
extends ItemFullProperty(‘iivp’, version = 0, flags = 0) {
          signed int(32) center_yaw;
          signed int(32) center_pitch;
          singed int(32) center_roll;
                    if (range_included_flag) {
                    unsigned int(32) hor_range;
          unsigned int(32) ver_range;
          }
          unsigned int(1) interpolate;
          bit(7) reserved = 0;
          unsigned int(1) refresh_flag;
          bit(7) reserved = 0;
}
```

Herein, the semantics for (each syntax element) of the InitialViewpointProperty information may include the following.

A center_yaw field, a center_pitch field, and a center_roll field may respectively indicate yaw, pitch, roll values of an initial viewport orientation being initially rendered to the user. The viewport orientation may be referred to as a viewing orientation.

When the value of a refresh_flag field is equal to 0, this may indicate that the indicated viewport orientation shall be used when starting (or initiating) playback from a time-parallel sample in an associated media track. When the value of the refresh_flag field is equal to 1, this may indicate that the indicated viewport orientation shall be used when rendering the time-parallel sample of each associated media track, i.e., including both continuous playback and playback from the time-parallel sample. In case the refresh_flag field is omitted or undefined, the value of the refresh_flag field may be deduced to be equal to 0.

Meanwhile, in case a projection structure being used in a coded image is not aligned with the global coordinate axes, the projection orientation for the omnidirectional image may be indicated based on the following methods.

According to an exemplary embodiment, the projection orientation may be indicated by using an initial viewpoint item property (or InitialViewpointProperty information). In case the projection orientation of the coded image is always the same as the initial viewing orientation within the image, the InitialViewpointProperty information may be used for the projection orientation functionality of the images. In this case, if the projection structure that is used in the coded image is not aligned with the global coordinate axes, the initial viewpoint item property (or InitialViewpointProperty information) may be used for the projection orientation functionality of the images.

As another exemplary embodiment, the projection orientation may be indicated by adding a projection orientation item property (or ProjectionOrientationProperty information). The projection orientation may indicate an orientation of a projection structure that is used in a coded omnidirectional image. In case an ERP image is used, the ProjectionOrientationProperty information may indicate the orientation of the sphere, i.e., yaw, pitch, and roll angles of a center pixel of the projected image before region-wise packing.

However, regardless of the orientation of the projection structure, the initial viewpoint indicates an initial viewing orientation relative to the global coordinate axes. Therefore, the initial viewing orientation may be different from the projection orientation that is used in the image. For example, the projection structure may be aligned with the global coordinate axes, and the initial viewpoint in contrast with the global coordinate axes may be set to (90, 0, 0). In this case, the initial viewpoint may be indicated as (90, 0, 0), so as to respectively specify (yaw, pitch, roll), and the projection orientation needs to be indicated as (0, 0, 0). Therefore, as described above in Tables 13 and 14, by defining a separate projection orientation item property, the projection orientation that is used in the image may be explicitly indicated.

Meanwhile, CoverageInformationProperty information may exist in an image item within a file. If a projected omnidirectional image does not cover an entire sphere, the CoverageInformationProperty information may exist in an image item within the file. For example, the CoverageInformationProperty information may be referred to as coverage information item property information or coverage property information, and this may include the following formats and/or definitions.

TABLE 17

Box type: ‘covi’
Property type: Descriptive item property
Container: ItemPropertyContainerBox
Mandatory (per an item): No
Quantity (per an item): Zero or one
CoverageInformationProperty is used to indicate the spherical
coverage of the projected omnidirectional image, i.e., the area
on the spherical surface that is represented by the projected
picture. The absence of CoverageInformationProperty indicates
that the omnidirectional image is a representation of full sphere.

The CoverageInformationProperty information may, for example, have the following syntax.

TABLE 18

```
aligned(8) class CoverageInformationProperty
extends ItemFullProperty(‘covi’, version = 0, flags = 0) {
          unsigned int(8) global_coverage_shape_type;
          SphereRegionStruct(1);
}
aligned(8) SphereRegionStruct(range_included_flag) {
          signed int(32) center_yaw;
          signed int(32) center_pitch;
          singed int(32) center_roll;
          if (range_included_flag) {
                    unsigned int(32) hor_range;
                    unsigned int(32) ver_range;
          }
          unsigned int(1) interpolate;
          bit(7) reserved = 0;
}
```

Herein, the semantics for (each syntax element) of the CoverageInformationProperty information may include the following.

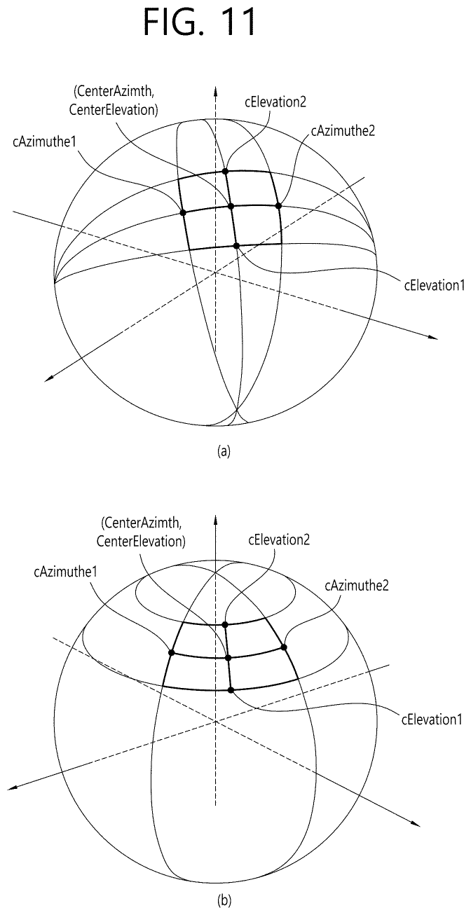

A global_coverage_shape_type field indicates the shape of a sphere region being covered by this image. For example, if the value of this type is equal to 0, this may indicate that the sphere region is specified as four great circles, as shown in (a) of FIG. 11. If the value of this type is equal to 1, this may indicate that the sphere region is specified as two azimuth circles and two elevation circles, as shown in (b) of FIG. 11.

A center_yaw field, a center_pitch field, and a center_roll field may indicate a center point of a sphere region being represented by packed pictures of the entire content. For example, these fields may indicate yaw, pitch, and roll angles in units of 2⁻¹⁶ degrees relative to a coordinate system being defined by the ProjectionOrientationBox. A value of the center_yaw field may be within a range of −180*2¹⁶ to 180*2¹⁶−1, inclusive, and a value of the center_pitch field may be within a range of −90*2¹⁶ to 90*2¹⁶−1, inclusive, and a value of the center_roll field may be within a range of −180*2¹⁶ to 180*2¹⁶−1, inclusive.

A hor_range field and a ver_range field may respectively indicate vertical and horizontal ranges of the sphere regions being represented by the packed pictures of the entire content. For example, these fields may indicate vertical/horizontal ranges in units of 2⁻¹⁶ degrees. The hor_range field and the ver_range field may indicate the above-described ranges via the center point of the sphere region. The hor_range field may indicate a range of 1 to 720*2¹⁶, inclusive, and the ver_range field may indicate a range of 1 to 720*2¹⁶, inclusive.

An interpolate field may indicate values of centre_azimuth, centre_elevation, centre_tilt, and azimuth_range (if present), and values of elevation_range (if present). The value of the interpolate field may be limited to 0 in SphereRegionStruct of the CoverageInformationProperty information.

Meanwhile, FisheyeOmnidirectionalImageProperty information may exist in an image item within a file. In case the image item includes a picture being configured of multiple circular images captured by fisheye cameras, the FisheyeOmnidirectionalImageProperty information may exist in the image item. For example, the FisheyeOmnidirectionalImageProperty information may be referred to as fisheye omnidirectional image item property, and this may include the following formats and/or definitions.

TABLE 19

Box type: ‘fovd’
Property type: Descriptive item property
Container: ItemPropertyContainerBox
Mandatory (per an item): No
Quantity (per an item): Zero or one
FisheyeOmnidirectionalImageProperty is used to indicate fisheye
video parameters of the image which consists of multiple circular
images captured by fisheye cameras.

For example, the FisheyeOmnidirectionalImageProperty information may have the following syntax.

TABLE 20

aligned(8) class FisheyeOmnidirectionalImageProperty
extends ItemFullProperty(‘fovd’, version = 0, flags = 0) {
FisheyeOmnidirectionalVideoInfo( );
}

A FisheyeOmnidirectionalVideoInfo field may include essential and/or supplemental fisheye parameters for performing stitching and rendering of a fisheye image. Multiple circular images being captured by fisheye cameras may be directly projected to a picture. The picture may be configured of omnidirectional fisheye images. In the receiver, the decoded omnidirectional fisheye video/image may be processed with stitching and/or rendering in accordance with a viewport intended by the user. And, in this case, diverse fisheye parameters may be used. For example, the following fisheye parameters may generally include at least one of the following parameters.

TABLE 21
1) Lens distortion correction (LDC) parameters with local variation of
FOV,
2) Lens shading compensation (LSC) parameters with RGB gains,
3) Displayed field of view information, and
4) Camera extrinsic parameters.

For example, parameters number 1), number 3), and number 4) may be included as the above-described essential fisheye parameters, and parameter number 2) may be included as the above-described supplemental fisheye parameter.

Although there is less or no distortion at the center of a fisheye lens, the distortion becomes larger in positions further away from the center of the lens. More specifically, in positions located further away from the center of the lens, since a distance between the pixels becomes greater, in order to calibrate such distance, information such as number 1) may be used. The parameter number 1) may be used for position calibration of the pixels. The parameter number 2) may be used for calibrating color values. The parameter number 3) indicates a FOV being rendered and displayed, and the parameter number 4) indicates camera coordinate offset information. The receiving device (or receiver) may calibrate the fisheye image based on the parameters number 1) to number 4). And, lens distortion calibration may be performed according to the parameter number 1), and pixel positions and color values may be calibrated by using RGB polynomial coefficients.

Meanwhile, in case the above-described FisheyeOmnidirectionalImageProperty information and RegionWisePackingProperty information exist in an image format, this may indicate that region-wise packing is applied to the one or more images acquired by the fisheye camera and that the corresponding one or more images are stored. In this case, for example, a circular image acquired by the fisheye camera, which corresponds to a front area of one image, may be stored at a high resolution and high picture quality, and a circular image acquired by the fisheye camera, which corresponds to a back area of one image, may be differently stored at a low resolution and low picture quality.

More specifically, for example, the FisheyeOmnidirectionalVideoInfo field may include syntaxes shown in Tables 22 and 23.

```
TABLE 22
aligned(8) class FisheyeOmnidirectionalVideoInfo( ) {
        bit(24) reserved = 0;
        unsigned int(8) num_circular_images;
        for(i=0; i< num_circular_images; i++) {
                unsigned int(32) image_center_x;
                unsigned int(32) image_center_y;
                unsigned int(32) full_radius;
                unsigned int(32) picture_radius;
                unsigned int(32) scene_radius;
                unsigned int(32) image_rotation;
                bit(30) reserved = 0;
                unsigned int(2) image_flip;
                unsigned int(32) image_scale_axis_angle;
                unsigned int(32) image_scale_x;
                unsigned int(32) image_scale_y;
                unsigned int(32) field_of_view;
                bit(16) reserved = 0;
                unsigned int (16) num_angle_for_displaying_fov;
                for(j=0; j< num_angle_for_displaying_fov; j++) {
                        unsigned int(32) displayed_fov;
                        unsigned int(32) overlapped_fov;
                }
                signed int(32) camera_center_yaw;
                signed int(32) camera_center_pitch;
                signed int(32) camera_center_roll;
                unsigned int(32) camera_center_offset_x;
                unsigned int(32) camera_center_offset_y;
                unsigned int(32) camera_center_offset_z;
                bit(16) reserved = 0;
                unsigned int(16) num_polynomial_coefficeients;
                for(j=0; j< num_polynomial_coefficients; j++) {
                        unsigned int(32) polynomial_coefficient_K;
                }
                bit(16) reserved = 0;
                unsigned int (16) num_local_fov_region;
                for(j=0; j<num_local_fov_region; j++) {
                unsigned int(32) start_radius;
                unsigned int(32) end_radius;
                signed int(32) start_angle;
                signed int(32) end_angle;
                unsigned int(32) radius_delta;
                signed int(32) angle_delta;
...
```

```
TABLE 23
...
    for(rad=start_radius; rad<= end_radius; rad+=radius_delta) {
    for(ang=start_angle; ang<= ang_radius; ang+=angle_delta) {
      unsigned int(32) local_fov_weight;
      }
    }
    }
    bit(16) reserved = 0;
    unsigned int(16) num_polynomial_coefficients_lsc;
    for(j=0; j< num_polynomial_coefficients_lsc; j++) {
      unsigned int (32) polynomial_coefficient_K_lsc_R;
      unsigned int (32) polynomial_coefficient_K_lsc_G;
      unsigned int (32) polynomial_coefficient_K_lsc_B;
    }
  }
  bit(24) reserved = 0;
  unsigned int(8) num_deadzones;
  for(i=0; i< num_deadzones; i++) {
    unsigned int(16) deadzone_left_horizontal_offset;
    unsigned int(16) deadzone_top_vertical_offset;
    unsigned int(16) deadzone_width;
    unsigned int(16) deadzone_height;
  }
}
```

The semantics for (each syntax element) of the FisheyeOmnidirectionalVideoInfo may include the following.

A num_circular_images field indicates a number of circular images in the coded picture of each sample to which this box is applied. For example, the value of the num_circular_images field may typically be equal to 2. However, other non-zero values are also possible.

A value of an image_center_x field is equal to a fixed-point 16.16 value, and this indicates a horizontal coordinate, in luma samples, at the center of the circular image in the coded picture of each sample to which this box is applied.

A value of an image_center_y field is equal to a fixed-point 16.16 value, and this indicates a vertical coordinate, in luma samples, at the center of the circular image in the coded picture of each sample to which this box is applied.

A value of a full_radius field is equal to a fixed-point 16.16 value, and this indicates a radius, in luma samples, from the center of the circular image to the edge of the full round image.

A value of a picture_radius field is equal to a fixed-point 16.16 value, and this indicates a radius, in luma samples, from the center of the circular image to the closest edge of the image border. The circular fisheye image may be cropped by a camera picture. Therefore, the value of this field may indicate the radius of a circle in which pixels are usable.

A value of a scene_radius field is equal to a fixed-point 16.16 value, and this specifies a radius, in luma samples, from the center of the circular image to the closest edge of the area in the image (where it is guaranteed that there are no obstructions from the camera body itself and that, within the enclosed area, there is no lens distortion being too large for stitching).

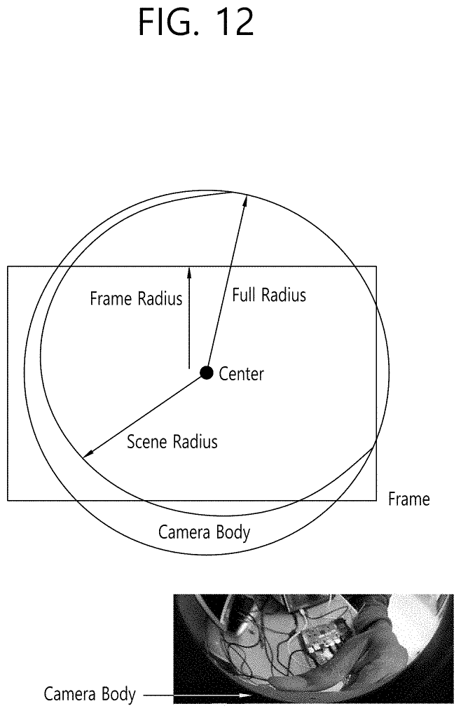

FIG. 12 shows an example of a full radius, a picture radius, and a scene radius. Herein, values of a full_radius field, a picture_radius field, and a scene_radius field may respectively indicate the full radius, the picture radius, and the scene radius. The picture radius may also be referred to as a frame radius.

The value of an image rotation field is equal to a fixed-point 16.16 value, and this may indicate an amount of rotation, in degrees, of the circular image. The image may be rotated by +/−90 degrees, or by +/−180 degrees, or by any other value.

An image_flip field may indicate whether or not an image is flipped, how the image is flipped, and whether or not a reverse flipping operation needs to be applied. For example, when the value of the image_flip field is equal to 1, this may indicate that the image is vertically flipped. When the value of the image_flip field is equal to 2, this may indicate that the image is horizontally flipped. And, when the value of the image_flip field is equal to 3, this may indicate that the image is flipped both vertically and horizontally.

An image_scale_axis_angle field, an image_scale_x field, and an image_scale_y field are equal to three fixed-point 16.16 values, and these specify whether or not the image is scaled along an axis and how the image is scaled. The axis may be defined by a single angle, in degrees, as indicated by the value of the image_scale_axis_angle field. In this case, a zero(0)-degree angle may mean that a horizontal vector is perfectly horizontal and that a vertical vector is perfectly vertical. Values of the image_scale_x field and the image_scale_y field may respectively indicate scaling ratios in directions that are parallel and orthogonal to the corresponding axis.

A field_of_view field is equal to a fixed-point 16.16 value, and this indicates the field of view (FOV) of a fisheye lens, in degrees. For example, the FOV value for a hemispherical fisheye lens is typically indicated as 180 degrees.

A num_angle_for_displaying_fov field may indicate a number of angles. The angles may define regions being displayed and overlapped. According to the value of the num_angle_for_displaying_fov field, a displayed_fov field and an overlapped_fov field may be defined with equal intervals, which start at 12 o'clock and go clockwise.

The displayed_fov field indicates a displayed field of view (FOV) and the corresponding image area of each fisheye camera image. The overlapped_fov field may indicate the region that includes overlapped regions, which are usually used for blending, in terms of the field of view between multiple circular images. The values of the displayed_fov field and the overlapped_fov field may be set to be equal to or less than the value of the field_of_view field.

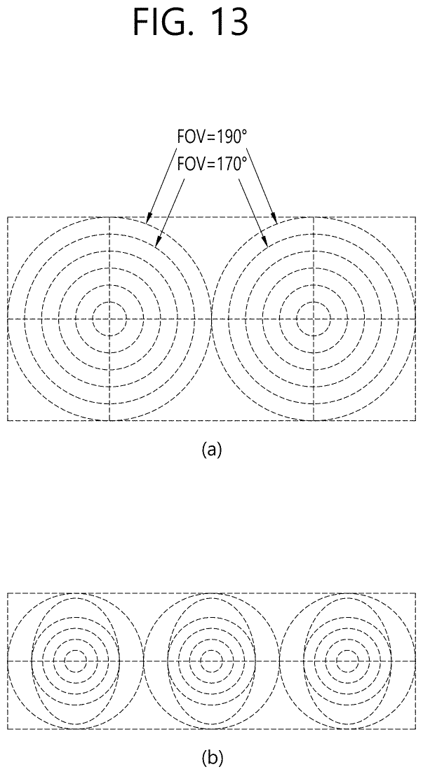

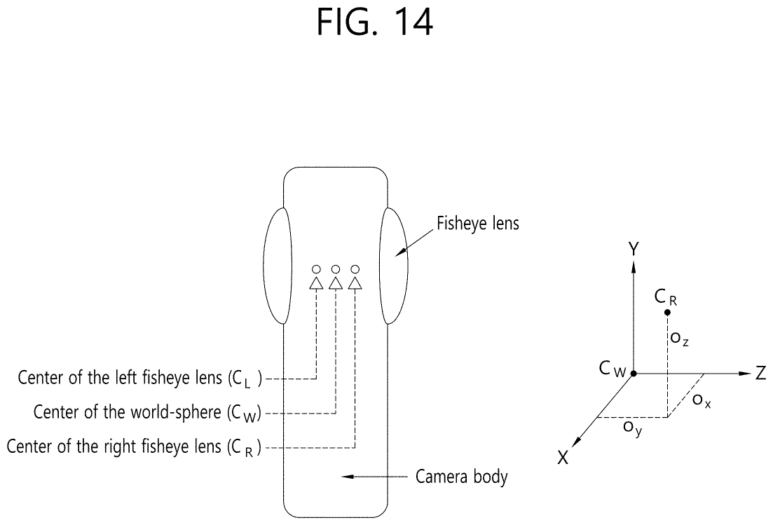

The value of field_of_view field may be determined based on the physical property of each fisheye lens, while the value of the displayed_fov field and the value of the overlapped_fov field may be determined by the configuration of multiple fisheye lenses. For example, in case the value of the num_circular_images field is equal to 2 and two lenses are symmetrically located, the value of displayed_fov field and the value of the overlapped_fov field may be respectively set to 180 and 190, by default. However, the value of displayed_fov field and the value of the overlapped_fov field may be changed depending on the configuration of the lens and the characteristics of the contents. For example, if the stitching quality with the displayed_fov values (left camera=170 and right camera=190) and the overlapped_fov values (left camera=185 and right camera=190) is better than the quality with the default values (180 and 190), or if the physical configuration of cameras is asymmetric, then, unequal displayed_fov and overlapped_fov values can be derived. In addition, in case of multiple (N>2) fisheye images, a single displayed_fov value may not specify the exact area of each fisheye image. FIG. 13 shows an exemplary FOV of fisheye images. (a) of FIG. 13 shows a displayed FOV for two fisheye cameras, and (b) of FIG. 13 shows a displayed FOV and an overlapped FOV for multiple fisheye cameras. As shown in FIG. 13, the displayed_fov field (marked as a hatched area) may vary depending upon the direction. In order to manipulate multiple (N>2) fisheye images, the num_angle_for_displaying_fov field may be adopted. For example, in case the value of the num_angle_for_displaying_fov field is equal to 12, then, the fisheye image may be divided into 12 sectors, wherein each sector angle may be equal to 30 degrees.

A camera_center_yaw field may indicate the yaw angle, in units of 2⁻¹⁶ degrees, of the point where the center pixel of the circular image in the coded picture of each sample is projected to a spherical surface. This corresponds to one of the 3 angles that indicate the camera extrinsic parameters relative to the global coordinate axes. The value of the camera_center_yaw field may be within the range of −180*2¹⁶ to 180*2¹⁶−1, inclusive.

A camera_center_pitch field may indicate the pitch angle, in units of 2⁻¹⁶ degrees, of the point where the center pixel of the circular image in the coded picture of each sample is projected to a spherical surface. The value of the camera_center_pitch field may be within the range of −90*2¹⁶ to 90*2¹⁶−1, inclusive.

A camera_center_roll field may indicate the roll angle, in units of 2⁻¹⁶ degrees, of the point where the center pixel of the circular image in the coded picture of each sample is projected to a spherical surface. The value of the camera_center_roll field may be within the range of −180*2¹⁶ to 180*2¹⁶−1, inclusive.

Values of a camera_center_offset_x field, a camera_center_offset_y field, and a camera_center_offset_z field are fixed-point 8.24 values, and these values indicate the XYZ offset values from the origin of a unit sphere to which pixels in the circular image in the coded picture are projected. The values of the camera_center_offset_x field, the camera_center_offset_y field, and the camera_center_offset_z field may be in the range of −1.0 to 1.0, inclusive.

A value of a num_polynomial_coefficients field is an integer, and this field indicates a number of polynomial coefficients that are present.

A list of polynomial coefficients polynomial_coefficient_K corresponds to fixed-point 8.24 values, and these values may indicate coefficients in the polynomial specifying transformation from a fisheye space to an undistorted planar image.

A num_local_fov_region field may indicate a number of local fitting regions having different field of views.

A start_radius field, an end_radius field, a start_angle field, and an end_angle field indicate specify the region for local fitting/warping in order to change the actual field of view for performing local display. The start_radius field and the end_radius field are fixed-point 16.16 values, and these values may respectively indicate the minimum and maximum radius values. The start_angle field and the end_angle field respectively indicate, in units of 2⁻¹⁶ degrees, the minimum and maximum angle values that start at 12 o'clock and increase clockwise. The value of the start_angle field and the value of the end_angle field may be in the range of −180*2¹⁶ to 180*2¹⁶−1, inclusive.

A radius_delta field is a fixed-point 16.16 value, and this field may indicate a delta radius value for representing a different field of view for each radius.

An angle_delta field indicates a delta angle value, in units of 2⁻¹⁶ degrees, for representing a different field of view for each angle.

A local_fov_weight field is a 8.24 fixed-point format, and this field may specify a weighting value for the field of view of the position specified by the start_radius field, the end_radius field, the start_angle field, and the end_angle field, within an angle index i and a radius index j. A positive value of the local_fov_weight field indicates an expansion of the field of view, whereas a negative value field specifies a contraction of the field of view.

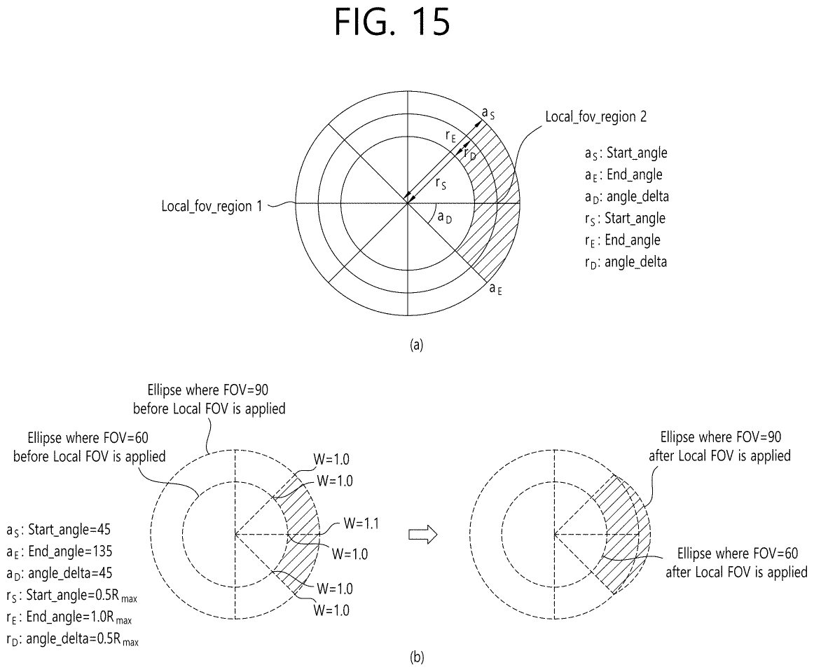

FIG. 15 shows an exemplary local FOV according to a parameter. A local FOV, as shown in FIG. 15, may be derived in accordance with the above-described parameters.

A num_polynomial_coefficients_lsc field may indicate a number of polynomial coefficients of lens shading compensation parameters relative to a circular image. In other words, the num_polynomial_coefficients_lsc field may indicate an order of the polynomial approximation of a lens shading curve. Hereinafter, LCS may indicate lens shading compensation or lens shading curve.

The value of a polynomial_coefficient_K_lsc_R field, the value of a polynomial_coefficient_K_lsc_G field, and the value of a polynomial_coefficient_K_lsc_B field are 8.24 fixed-point formats, and these values may indicate LCS parameters for a compensating shading artifact that reduces color along the radial direction. A compensating weight (w) being multiplied by the original color is approximated as a curve function of the radius from the image center by using a polynomial expression (or equation). In this case, the equation may be indicated as shown below.

w=Σᵢ₌₁^{N}pᵢ₋₁·rⁱ⁻¹ [Equation 5]

Herein, p may indicate a coefficient value that is equal to the value of the polynomial_coefficient_K_lsc_R field, the value of the polynomial_coefficient_K_lsc_G field, or the value of the polynomial_coefficient_K_lsc_B field. r may indicate a radius value after performing normalization by using the full_radius. N may be equal to the value of the num_polynomial_coefficients_lsc field.

The value of a num_deadzones field is an integer, and this field may indicate a number of dead zones in the coded picture of each sample to which this box is applied.

Each of the value of a deadzone_left_horizontal_offst field, the value of a deadzone_top_vertical_offset field, the value of a deadzone_width field, and the value of a deadzone_height field is an integer, and these values may indicate the position and size of a deadzone rectangular area in which the pixels are not usable. The deadzone_left_horizontal_offset field and the deadzone_top_vertical_offset field respectively indicate, in luma samples units, horizontal and vertical coordinates of an upper left corner of the deadzone in the coded picture. The deadzone_width field and the deadzone_height field respectively indicate, in luma samples, the width and height of the deadzone. In order to save the bits used for representing the video, all pixels within the deadzone shall be set to have the same value. For example, all pixels within the deadzone may all be set to a block pixel value.

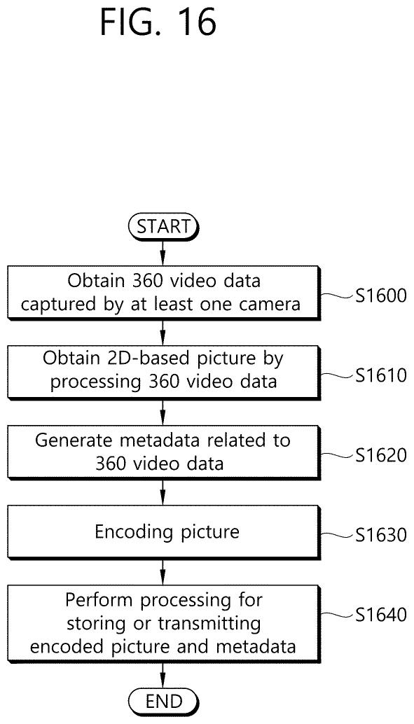

FIG. 16 shows a general view of a 360 video data processing method performed by a 360 video transmitting device according to the present invention. The method shown in FIG. 16 may be performed by the 360 video transmitting device, which is disclosed in FIG. 5. More specifically, for example, S1600 of FIG. 16 is performed by a data input unit of the 360 video transmitting device, S1610 of FIG. 16 is performed by a projection processor of the 360 video transmitting device, S1620 of FIG. 16 is performed by a metadata processor of the 360 video transmitting device, S1630 of FIG. 16 is performed by a data encoder of the 360 video transmitting device, and S1640 of FIG. 16 is performed by a transmission processor of the 360 video transmitting device. The transmission processor may be included in a transmitting unit.

The 360 video transmitting device acquires (or obtains) 360 video data (S1600). The 360 video transmitting device may acquire 360 video data being captured by at least one camera. The 360 video data may correspond to a video that is captured by at least one camera. Additionally, for example, the at least one camera may correspond to a fish-eye camera.

The 360 video transmitting device processes the 360 video data and acquires a 2D-based picture (S1610). Among diverse projections, the 360 video transmitting device 360 may perform a projection in accordance with a projection format for the 360 video data. The diverse projection formats may include the diverse projection formats that are described above. For example, the projection formats may include equirectangular projection, cubic projection, octahedron projection, icosahedron projection, cylinder-type projection, tile-based projection, pyramid projection, panoramic projection, and so on. Meanwhile, the at least one camera may correspond to a fish-eye camera, and, in this case, an image acquired by each camera may correspond to a (fish-eye) circular image. In this case, the 360 video transmitting device may generate a 360 video without stitching.

Additionally, in case the 360 data is stitched, the 360 video transmitting device may stitch the 360 video data, and the stitched 360 video data may be projected to the 2D-based picture. Additionally, in case the 360 video is not stitched, the 360 video transmitting device may project the 360 video data on the 2D-based picture without stitching. Herein, the 2D-based picture may be referred to as a 2D image or may be referred to as a projected picture. Meanwhile, as described above, in case region-wise packing is applied, a packed picture may be generated based on the projected picture, and the 2D-based picture may include a packed picture.

The 360 video transmitting device generates metadata for the 360 video data (S1620). Herein, the metadata for the 360 video data may include fields that are described above in this specification. The fields may be included a box having multiple levels or may be included as data within a separate track of a file. For example, the metadata for the 360 video data may include at least one of the above-described FramePackingProperty information, ProjectionFormatProperty information, RegionWisePackingProperty information, ProjectionOrientationProperty information, Initial ViewpointProperty information, CoverageInformationProperty information, and FisheyeOmnidirectionalImageProperty information.

For example, projection orientation rotation may be applied to the projected picture based on at least one of a yaw angle, a pitch angle, and a roll angle, and, in this case, the metadata may include the ProjectionOrientationProperty information that is related to the projection orientation rotation. The ProjectionOrientationProperty information may include a yaw field, a pitch field, and a roll field respectively indicating the yaw angle, the pitch angle, and the roll angle of a center point of the projected picture, for example, in a case where the projected picture is projected to a spherical surface, as described above.

As another example, the metadata may include the CoverageInformationProperty information indicating a coverage of an omnidirectional image. The CoverageInformationProperty information may, for example, include a coverage shape type field, as described above, and the coverage shape type field may indicate the shape of a sphere region corresponding to the coverage of the omnidirectional image.

As yet another example, the metadata may include the InitialViewpointProperty information. The InitialViewpointProperty information may, for example, indicate an initial viewport orientation relative to the global coordinate axes, as described above. The initial viewport orientation may indicate viewport orientation of an image that should be initially rendered to the user. Additionally, the InitialViewpointProperty information may include refresh_flag information. When the value of the refresh_flag information is equal to 0, this may indicate that the initial viewport orientation is used when playback is started from a time-parallel sample within an associated media track. And, when the value of the refresh_flag information is equal to 1, this may indicate that the initial viewport orientation is used when the initial viewport orientation is rendered to the time-parallel sample of each associated media track.

As yet another example, in case the fish-eye camera is used, the metadata may include FisheyeOmnidirectionalImageProperty information. For example, the FisheyeOmnidirectionalImageProperty information may include at least one of lens distortion correction (LDC) parameters related to a fish-eye lens of the fish-eye camera, field of view (FOV) information of the circular image, camera extrinsic parameters, and lens shading compensation (LSC) parameters. The LDC parameters may include camera center offset x information, camera center offset y information, and camera center offset z information, and the camera center offset x information, the camera center offset y information, and the camera center offset z information may respectively indicate x, y, z offset information of the fish-eye lens corresponding to a circular image. The LSC parameters may include information on a number of polynomial coefficients and polynomial coefficient information, and the information on a number of polynomial coefficients may indicate a number of polynomial coefficients corresponding to the circular image, and the polynomial coefficient information may include a value of at least one polynomial coefficient.

Meanwhile, the metadata may be transmitted via SEI message. Additionally, the metadata may be included in AdaptationSet, Representation, or SubRepresentation of Media Presentation Description (MPD). Herein, the SEI message may be used for the decoding a 2D image or for supplementing the display of a 2D image to a 3D space.

The 360 video transmitting device encodes the picture (S1630). The 360 video transmitting device may encode the picture. Additionally, the 360 video transmitting device may encode the metadata.

The 360 video transmitting device performs processing for storing or transmitting the encoded picture and the metadata (S1640). The 360 video transmitting device may encapsulate the encoded 360 video data and/or the metadata in a file format. In order to store or transmit the encoded 360 video data and/or the metadata, the 360 video transmitting device may encapsulate the data in a file format such as ISOBMFF, CFF, and so on, or process the data into other DASH segments, and so on. The 360 video transmitting device may include the metadata in a file format. For example, the metadata may be included in a box having various levels in SOBMFF or may be included as data of a separate track in a file. Additionally, the 360 video transmitting device may encapsulate the metadata itself into a file. The 360 video transmitting device may perform processing for transmission on the encapsulated 360 video data according to file format. And, the 360 video transmitting device may process the 360 video data according to an arbitrary transmission protocol. The processing for transmission may include processing for delivery over a broadcast network or processing for delivery over a broadband. Additionally, the 360 video transmitting device may also apply the processing for transmission on the metadata. The 360 video transmitting device may transmit the 360 video data and the metadata over the broadcast network and/or broadband.

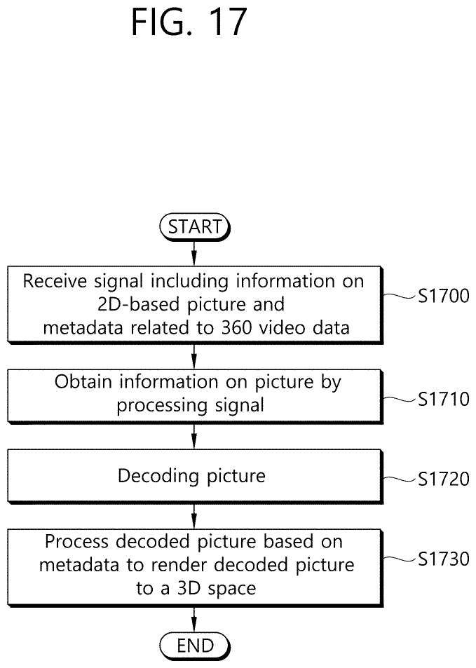

FIG. 17 shows a general view of a 360 video data processing method performed by a 360 video receiving device according to the present invention. The method shown in FIG. 17 may be performed by the 360 video receiving device, which is disclosed in FIG. 6. More specifically, for example, S1700 of FIG. 17 is performed by a receiving unit of the 360 video receiving device, S1710 of FIG. 17 is performed by a reception processor of the 360 video receiving device, S1720 of FIG. 17 is performed by a data decoder of the 360 video receiving device, and S1730 of FIG. 17 is performed by a renderer of the 360 video receiving device.

The 360 video receiving device receives a signal including information on a 2D-based picture related to the 360 video data and metadata related to the 360 video data (S1700). The 360 video receiving device may receive the signaled information on the 2D-based picture related to the 360 video data and the metadata from the 360 video transmitting device over the broadcast network. Additionally, the 360 video receiving device may receive the information on the 2D-based picture related to the 360 video data and the metadata through a communication network, such as broadband, or a storage medium. Herein, the 2D-based picture may be referred to as a 2D image picture, or the 2D-based picture may also be referred to as a projected picture or packed picture (in case region-wise packing is applied).

The 360 video receiving device acquires (or obtains) the information on the picture and the metadata after processing the received signal (S1710). The 360 video receiving device may perform processing according to a transmission protocol on the information on the picture and the metadata. Additionally, the 360 video receiving device may perform an inverse process of the processing for the transmission of the above-described 360 video transmitting device.

Herein, the metadata for the 360 video data may include fields that are described above in this specification. The fields may be included a box having multiple levels or may be included as data within a separate track of a file. For example, the metadata for the 360 video data may include at least one of the above-described FramePackingProperty information, ProjectionFormatProperty information, RegionWisePackingProperty information, ProjectionOrientationProperty information, Initial ViewpointProperty information, CoverageInformationProperty information, and FisheyeOmnidirectionalImageProperty information.

For example, projection orientation rotation may be applied to the projected picture based on at least one of a yaw angle, a pitch angle, and a roll angle, and, in this case, the metadata may include the ProjectionOrientationProperty information that is related to the projection orientation rotation. The ProjectionOrientationProperty information may include a yaw field, a pitch field, and a roll field respectively indicating the yaw angle, the pitch angle, and the roll angle of a center point of the projected picture, for example, in a case where the projected picture is projected to a spherical surface, as described above. The 360 video receiving device may perform rendering by applying projection orientation rotation on at least one of a yaw angle, a pitch angle, and a roll angle on the decoded picture based on the ProjectionOrientationProperty information.

As another example, the metadata may include the CoverageInformationProperty information indicating a coverage of an omnidirectional image. The CoverageInformationProperty information may, for example, include a coverage shape type field, as described above, and the coverage shape type field may indicate the shape of a sphere region corresponding to the coverage of the omnidirectional image.

As yet another example, the metadata may include the InitialViewpointProperty information. The InitialViewpointProperty information may, for example, indicate an initial viewport orientation relative to the global coordinate axes, as described above. The initial viewport orientation may indicate viewport orientation of an image that should be initially rendered to the user. Additionally, the InitialViewpointProperty information may include refresh_flag information. When the value of the refresh_flag information is equal to 0, this may indicate that the initial viewport orientation is used when playback is started from a time-parallel sample within an associated media track. And, when the value of the refresh_flag information is equal to 1, this may indicate that the initial viewport orientation is used when the initial viewport orientation is rendered to the time-parallel sample of each associated media track.

As yet another example, in case the fish-eye camera is used, the metadata may include FisheyeOmnidirectionalImageProperty information. For example, the FisheyeOmnidirectionalImageProperty information may include at least one of lens distortion correction (LDC) parameters related to a fish-eye lens of the fish-eye camera, field of view (FOV) information of the circular image, camera extrinsic parameters, and lens shading compensation (LSC) parameters. The LDC parameters may include camera center offset x information, camera center offset y information, and camera center offset z information, and the camera center offset x information, the camera center offset y information, and the camera center offset z information may respectively indicate x, y, z offset information of the fish-eye lens corresponding to a circular image. The LSC parameters may include information on a number of polynomial coefficients and polynomial coefficient information, and the information on a number of polynomial coefficients may indicate a number of polynomial coefficients corresponding to the circular image, and the polynomial coefficient information may include a value of at least one polynomial coefficient.

Meanwhile, the metadata may be transmitted via SEI message. Additionally, the metadata may be included in AdaptationSet, Representation, or SubRepresentation of Media Presentation Description (MPD). Herein, the SEI message may be used for the decoding a 2D image or for supplementing the display of a 2D image to a 3D space.

The 360 video receiving device decodes the picture based on information on the picture (S1720). The 360 video receiving device may decode the picture based on the information on the picture.

The 360 video receiving device processes the decoded picture based on the metadata and renders the processed decoded picture to a 3D space (S1730).

According to the exemplary embodiments, the above-described process steps may be omitted or replaced by other process step(s) performing similar/identical operations.

According to an exemplary embodiment of the present invention, the 360 video transmitting device may include the above-described data input unit, stitcher, signaling processor, projection processor, data encoder, transmission processor, and/or transmitting unit. Each of the internal components have already been described above. The 360 video transmitting device according to the exemplary embodiment of the present invention and its internal components may perform the above-described exemplary embodiments of the method for transmitting the 360 video according to the present invention.

The 360 video receiving device according to the exemplary embodiment of the present invention may include the above-described receiving unit, reception processor, data decoder, signaling parser, re-projection processor, and/or renderer. Each of the internal components have already been described above. The 360 video receiving device according to the exemplary embodiment of the present invention and its internal components may perform the above-described exemplary embodiments of the method for receiving the 360 video according to the present invention.

The internal components of the apparatuses illustrated above may be processors executing successive processes stored in a memory or may be hardware components configured with other hardware. These components may be disposed inside or outside the apparatuses.

The foregoing modules may be omitted according to the embodiment or may be replaced by other modules for performing similar/equivalent operations.

Each of the foregoing parts, modules, or units may be a processor or a hardware part that executes successive processes stored in a memory (or storage unit). Each step described in the foregoing embodiments may be performed by a processor or hardware part. Each module/block/unit described in the foregoing embodiments may operate as a hardware/processor. Further, the methods proposed by the present invention may be executed as codes. These codes may be written in a processor-readable storage medium and may thus be read by a processor provided by an apparatus.

Although the foregoing embodiments illustrate the methods based on a flowchart having a series of steps or blocks, the present invention is not limited to the order of the steps or blocks. Some steps or blocks may occur simultaneously or in a different order from other steps or blocks as described above. Further, those skilled in the art will understand that the steps shown in the above flowcharts are not exclusive, that further steps may be included, or that one or more steps in the flowcharts may be deleted without affecting the scope of the present disclosure.

When the embodiments of the present invention are implemented in software, the foregoing methods may be implemented by modules (processes, functions, or the like) that perform the functions described above. Such modules may be stored in a memory and may be executed by a processor. The memory may be inside or outside the processor and may be connected to the processor using various well-known means. The processor may include an application-specific integrated circuit (ASIC), other chipsets, a logic circuit, and/or a data processing device. The memory may include a read-only memory (ROM), a random access memory (RAM), a flash memory, a memory card, a storage medium, and/or other storage devices.

What is claimed is:

1. A 360-degree video data processing method performed by a 360-degree video transmitting apparatus, the method comprising:
obtaining 360-degree video data being captured by at least one or more cameras;
deriving a two-dimensional (2D)-based picture including an omnidirectional image by processing the 360-degree video data;
generating metadata related to the 360-degree video data;
encoding the picture; and
performing processing for storage or transmission of the encoded picture and the metadata,
wherein the deriving a 2D-based picture includes a step of:
deriving a projected picture by performing a projection procedure related to the 360-degree video data,
wherein the 2D-based picture corresponds to the projected picture or corresponds to a packed picture being derived by performing a region-wise packing procedure related to the projected picture,
wherein projection orientation rotation is applied to the projected picture based on at least one of a yaw angle, a pitch angle, and a roll angle, and
wherein the metadata includes projection orientation property information related to the projection orientation rotation.

2. The method of claim 1, wherein the projection orientation property information includes a yaw field, a pitch field and a roll field representing the yaw angle, the pitch angle and the roll angle, respectively, of a center point of the projected picture for a case that the projected picture is projected into a sphere surface.

3. The method of claim 1, wherein the metadata includes coverage property information representing a coverage of the omnidirectional image.

4. The method of claim 3, wherein the coverage property information includes a coverage shape type field, and wherein the coverage shape type field represents a shape of a sphere region corresponding to the coverage of the omnidirectional image.

5. The method of claim 1, wherein the metadata includes initial viewport property information, and
wherein the initial viewport property information represents initial viewport orientation relative to a global coordinate axes.

6. The method of claim 5, wherein the initial viewport property information includes refresh flag information, and
wherein value 0 of the refresh flag information indicates that the initial viewport orientation is used when starting playback from a time-parallel sample within an associated media track, and value 1 of the refresh flag information indicates that the initial viewport orientation is used when rendering is performed to the time-parallel sample of each associated media track.

7. The method of claim 1, wherein the at least one camera is at least one fisheye camera,
wherein the metadata includes fisheye omnidirectional image property information, and
wherein the fisheye omnidirectional image property information includes lens distortion correction (LDC) parameters for a fisheye lens of the fisheye camera.

8. The method of claim 7, wherein the fisheye omnidirectional image property information includes field of view (FOV) information of a circular image.

9. The method of claim 7, wherein the fisheye omnidirectional image property information includes camera extrinsic parameters for the fisheye camera.

10. The method of claim 7, wherein the fisheye omnidirectional image property information includes lens shading compensation (LSC) parameters,
wherein the LSC parameters include number information on polynomial coefficients and polynomial coefficient information, and
wherein the number information on the polynomial coefficients represents a number of the polynomial coefficients for a circular image, and the polynomial coefficient information represents a value of at least one polynomial coefficient.

11. A 360-degree video data processing method performed by a 360-degree video receiving apparatus, the method comprising:
receiving a signal including information on a 2D based picture for 360-degree video and metadata for the 360-degree video;
processing the signal to obtain the information on the 2D based picture and the metadata;
decoding the 2D based picture based on the information on the 2D based picture; and
rendering the decoded picture on a 3D space by processing the decoded picture based on the metadata,
wherein the metadata includes projection orientation property information on the projection orientation rotation, and
wherein the rendering is performed by applying orientation rotation for at least one of yaw angle, pitch angle and roll angle about the decoded picture based on the projection orientation property information.

12. The method of claim 11, wherein the projection orientation property information includes a yaw field, a pitch field and a roll field representing the yaw angle, the pitch angle and the roll angle, respectively, of a center point of the projected picture for a case that the projected picture is projected into a sphere surface.

13. The method of claim 11, wherein the metadata includes coverage property information representing a coverage of the omnidirectional image.

14. The method of claim 13, wherein the coverage property information includes a coverage shape type field, and wherein the coverage shape type field represents a shape of a sphere region corresponding to the coverage of the omnidirectional image.

15. The method of claim 11, wherein the metadata includes initial viewport property information, and
wherein the initial viewport property information represents initial viewport orientation relative to a global coordinate axes.

16. The method of claim 15, wherein the initial viewport property information includes refresh flag information, and
wherein value 0 of the refresh flag information indicates that the initial viewport orientation is used when starting playback from a time-parallel sample within an associated media track, and value 1 of the refresh flag information indicates that the initial viewport orientation is used when rendering is performed to the time-parallel sample of each associated media track.

17. The method of claim 11, wherein the at least one camera is at least one fisheye camera,
wherein the metadata includes fisheye omnidirectional image property information, and
wherein the fisheye omnidirectional image property information includes lens distortion correction (LDC) parameters for a fisheye lens of the fisheye camera.

18. The method of claim 17, wherein the fisheye omnidirectional image property information includes field of view (FOV) information of a circular image, and
wherein the fisheye omnidirectional image property information includes camera extrinsic parameters for the fisheye camera.

19. The method of claim 17, wherein the fisheye omnidirectional image property information includes lens shading compensation (LSC) parameters,
wherein the LSC parameters include number information on polynomial coefficients and polynomial coefficient information, and
wherein the number information on the polynomial coefficients represents a number of the polynomial coefficients for a circular image, and the polynomial coefficient information represents a value of at least one polynomial coefficient.

20. A 360-degree video transmitting apparatus, comprising:
a data input unit obtaining 360-degree video data being captured by at least one or more cameras;
a projection processor obtaining a two-dimensional (2D)-based picture by processing the 360-degree video data;
a metadata processor generating metadata related to the 360-degree video data;
an encoder encoding the picture; and
a transmission processor performing processing for storage or transmission of the encoded picture and the metadata,
wherein the projection processor derives a projected picture corresponding to the 2D-based picture by performing a projection procedure related to the 360-degree video data,
wherein the projection processor applies projection orientation rotation to the projected picture based on at least one of a yaw angle, a pitch angle, and a roll angle, and
wherein the metadata processor generates the metadata including projection orientation property information related to the projection orientation rotation.
